(19) United States
(12) Patent Application Publication
(10) Pub. No.: US 2026/0094226 A1
(43) Pub. Date: Apr. 2, 2026

(54) SYSTEM AND METHOD FOR ENHANCING SPECTATOR EXPERIENCE DURING AN EVENT

(71) Applicants: Gordon C. ROOT, West Linn, OR (US); Jeffrey James RUSSELL, Fountain Hills, AZ (US)

(72) Inventors: Gordon C. ROOT, West Linn, OR (US); Jeffrey James RUSSELL, Fountain Hills, AZ (US)

(21) Appl. No.: 18/898,558

(22) Filed: Sep. 26, 2024

Related U.S. Application Data
(60) Provisional application No. 63/585,572, filed on Sep. 26, 2023.

(51) Int. Cl. G06Q 50/34; G07F 17/32

(52) U.S. Cl. CPC G06Q 50/34; G07F 17/323; G07F 17/3237; G07F 17/3258; G07F 17/3288

(57) ABSTRACT

A system and method for enhancing spectator experience during an event includes a communication subsystem configured to acquire event-related data (ERD) for the event. In addition, the system includes a targeting module configured to select a target group of spectators based on a predetermined criterion. Further, the system includes a transmission module configured to transmit the acquired ERD to the target group of spectators. Furthermore, the system includes an engagement module allowing the target group of spectators to interact with the event by using the ERD, causing the spectators to have an enhanced spectator experience. Also, the event for enhancing spectator with the system is but not limited to a motorsport race, an animal event, an auction, and a bike race.

### CROSS-REFERENCE TO RELATED APPLICATION

This application claims priority to U.S. Provisional Patent Application Ser. No. 63/585,572, filed Sep. 26, 2023 and entitled SYSTEM AND METHOD FOR ENHANCING SPECTATOR EXPERIENCE WITH AN EVENT, the disclosure of which is incorporated herein by reference in its entirety.

### FIELD OF THE INVENTION

The present inventions relate broadly to spectator experiences at events, and specific ones of the inventions relate to spectator experiences at motorsports events, auction events, and animal events. Each of the inventions includes methods and systems that facilitate spectators'interaction with events, enhancing spectators'experience during the event.

### BACKGROUND

Spectator events continue to attract millions of spectators, many of whom are fans, if the events are sports competitions, including motorsports races, or games and matching involving sports, such as football, basketball, baseball and soccer. Spectators engage with those events typically in a passive way by watching them, either live, or by broadcast, cable or streaming. Spectators also engage with events by betting on the outcomes, using conventional platforms.

In addition to sporting events, there are a wide range of other events that involve spectators, and those events include auctions, rodeos, animal events such as equine events and dog shows.

The present inventions provide systems and methods to enhance spectators'experiences at events. One version of the inventions is a system and method for implementing pari-mutuel wagering in sports events worldwide. This system leverages the existing infrastructure already designed for pari-mutuel betting on sports events, including dedicated software, betting outlets, web pages, and apps. By adapting and extending this infrastructure to encompass a wide variety of sports, the invention opens up the opportunity for spectators to interact with sports events through wagering.

The inventions amalgamate event-related data and then integrate that data into a system and method that allows spectators to make informed wagers. Event-related data may include team statistics, player information, historical performance, real-time match or game statistics, and other pertinent data that enrich the spectator's understanding of the event and increase their engagement. This data-driven approach provides a valuable connection between the sporting event and the spectator's betting experience.

The integration of pari-mutuel wagering into sports events offers a novel and exciting way for spectators to enjoy the games they love. It transforms them from passive observers into active participants, contributing to and sharing in the wagering pool. This not only enhances the excitement of sports events but also fosters a sense of community and engagement among fans.

In summary, versions of the invention bridge the world of sports events with the established framework of pari-mutuel betting, providing fans with an innovative and interactive way to connect with their favorite sports. By capitalizing on existing infrastructure and offering a platform for wagering on a variety of sports and other events, the system and method enhances the spectator experience by offering a more immersive and engaging one to event spectators worldwide.

### OBJECTIVES OF THE DISCLOSURE

A primary objective of the present invention is to offer ways to enhance spectators'experiences.

Another objective of the present invention is to establish a novel approach for sports betting, introducing the concept of pari-mutuel wagering to motorsports and other sports events. The objective is to enhance the enjoyment and engagement of sports enthusiasts by enabling them to actively participate in wagering on their favorite teams, athletes, or sporting events.

Yet another objective of the present invention is to extend the functionality of pari-mutuel wagering on various sports events, creating a seamless transition for both betting operators and spectators.

Yet another objective of the present invention is to provide spectators with event-related data that informs their wagering decisions. This data may include real-time statistics, historical performance, player or team profiles, and other relevant information, enriching the betting experience. The objective is to enable informed wagering and enhance the connection between the spectator and the sports event.

Yet another objective of the present invention is to transform spectators from passive observers into active participants, offering them an engaging and interactive role in the sports event. The objective is to create a more immersive and dynamic spectator experience by allowing spectators to wager on various aspects of the event, thus increasing their emotional investment and enjoyment.

Yet another objective of the present invention is to provide a universally accessible platform for sports betting and engagement.

### SUMMARY OF THE INVENTION

The following is a summary description of illustrative embodiments of the invention. It is provided as a preface to assist those skilled in the art to more rapidly assimilate the detailed design discussion which ensues and is not intended in any way to limit the scope of the claims which are appended hereto in order to particularly point out the invention.

An embodiment of the present invention relates to a system for use in relation to an event produced by an event producer, the event occurring between a beginning time and an end time and producing one or more categories of interim outcomes. The interim outcomes are unknown prior to the beginning time, and the system identifies categories of interim outcomes to a target group of spectators. The system also reports to the target group of spectators in a period between the beginning time and the end time, the interim outcomes as they become known during the event, measures a level of spectator engagement with the event.

The system also includes a communication subsystem that acquires event-related data (ERD), the ERD including the one or more categories of interim outcomes before the beginning time of the event and the interim outcomes as they become known during the event. In addition, the system includes a targeting module configured to select the target group of spectators based on a predetermined criterion. Further, the system includes a transmission module configured to transmit the acquired ERD to the target group of spectators before the beginning time of the event and during the event and an engagement module allowing the target group of spectators to interact with the event by using the ERD and the engagement module measuring the level of spectator engagement.

In accordance with an embodiment of the present invention, the system further includes a wager offering module configured to offer wagers to the target group of spectators on interim outcomes between the beginning time and the end time.

In accordance with an embodiment of the present invention, the engagement module allows for the target group of spectators to place wagers between the beginning time and the end time on one or more of the interim outcomes.

In accordance with an embodiment of the present invention, the engagement module measures the level of spectator engagement based at least in part from the wagers placed by the target group of spectators.

In accordance with an embodiment of the present invention, the engagement module measures the level of spectator engagement based on at least one factor chosen from the group consisting of participating in the event, having an emotional experience during the event, enjoying the event more than they would have without the system, betting on the outcome of the event, or a combination of each of those things.

In accordance with an embodiment of the present invention, the system further includes a data processing module configured to analyze the ERD and provide real-time odds for betting on the event outcome based on the analyzed data.

In accordance with an embodiment of the present invention, the communication subsystem further includes one or more sensors for real-time data acquisition of the event.

In accordance with an embodiment of the present invention, the predetermined criteria for selecting the target group of spectators includes at least one of geographical location, user preferences, and user demographics.

In accordance with an embodiment of the present invention, the engagement module enables the target group of spectators to place bets on various event outcomes chosen from the group consisting of final times, final scores, driver statistics, player statistics, specific race events, and specific game events.

In accordance with an embodiment of the present invention, a two-way communication is established between the event and the spectator, wherein the two-way communication allows the spectator to have enhanced engagement with the event.

In accordance with an embodiment of the present invention, the event is, but not limited to, a motorsports race, an animal event, a car race, and an auction.

An embodiment of the present invention relates to a method for enhancing the spectator experience during an event. The method includes the steps of acquiring event-related data (ERD) for an event using a communication subsystem, selecting a target group of spectators based on predetermined criteria, transmitting the acquired ERD to the target group of spectators and allowing the target group of spectators to engage with the event by using the ERD, causing the spectators to have an enhanced spectator experience.

In accordance with an embodiment of the present invention, the enhanced spectator experience caused by the allowing step is chosen from the group consisting of participating in the event, having an emotional experience during the event, enjoying the event more than they would have without the system, betting on the outcome of the event, or a combination of each of those things.

In accordance with an embodiment of the present invention, the method further includes real-time analysis of the ERD to provide updated odds for betting to the target group of spectators.

In accordance with an embodiment of the present invention, the predetermined criteria for selecting the target group of spectators includes at least one of geographical location, user preferences, and user demographics.

In accordance with an embodiment of the present invention, the step of allowing the target group of spectators to engage with the event includes placing bets on various event outcomes chosen from the group consisting of final times, final scores, driver statistics, player statistics, specific race events, and specific game events.

In accordance with an embodiment of the present invention, all the ERD is amalgamated into a standardized date format to enable transmission through a plurality of third parties involved in the event.

An embodiment of the present invention relates to a system for use in relation to a motorsport race produced by an event producer, the system configured for collecting wagers from a betting populace and for allocating a portion of the wagers as revenue to the event producer and for enhancing spectator experience during a motorsport race. The system includes a communication subsystem configured to acquire motorsport race-related data (MRRD) for the motorsport race. In addition, the system includes a targeting module configured to select a target group of spectators based on a predetermined criteria. Further, the system includes a transmission module configured to transmit the acquired MRRD to the target group of spectators. Furthermore, the system includes an engagement module configured to allow the target group of spectators to interact with the motorsport race by using the MRRD to place parimutuel wagers about motorsport race outcomes. Also, the system includes an allocation module configured to designate and transmit to the event producer a portion of the parimutuel wagers.

In accordance with an embodiment of the present invention, the system further includes a data processing module configured to amalgamate and reformat the MRRD into a standardized data feed that is receivable by parimutuel platforms that provide real-time odds for betting based upon the analyzed data.

In accordance with an embodiment of the present invention, the communication subsystem is also configured to acquire transmission signals of live motorsport races, chosen from the group consisting of broadcast and streaming signals.

In accordance with an embodiment of the present invention, the engagement module is also configured to allow the target group of spectators to use the MRRD to place bets, including over and under ones, about aspects of a motorsport race chosen from the group consisting of the driver who had the lead for the most laps, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.

In accordance with an embodiment of the present invention, the communication subsystem further comprises one or more sensors for real-time data acquisition of the motorsport race.

In accordance with an embodiment of the present invention, the predetermined criteria for selecting the target group of spectators includes at least one of geographical location, user preferences, and user demographics.

In accordance with an embodiment of the present invention, the engagement module enables the target group of spectators to place parimutuel wagers on the finish order.

In accordance with an embodiment of the present invention, a two-way communication is established between the motorsport race and the spectator, wherein the two-way communication allows the spectator to have enhanced engagement with the motorsport race.

An embodiment of the present invention relates to a method for enhancing the spectator experience during an motorsport race. The method includes the steps of acquiring motorsport race-related data (MRRD) for a motorsport race using a communication subsystem, selecting by a targeting module, a target group of spectators based on predetermined criteria, transmitting by a transmitting module, the acquired MRRD to the target group of spectators; and allowing the target group of spectators to engage with the motorsport race by using the MRRD to place parimutuel wagers about motorsport race outcomes.

In accordance with an embodiment of the present invention, the method further includes amalgamating and reformatting the MRRD into a standardized data feed that is receivable by parimutuel platforms that provide real-time odds for betting based upon the analyzed data.

In accordance with an embodiment of the present invention, the acquiring step also acquires transmission signals of live motorsport races, chosen from the group consisting of broadcast and streaming signals.

In accordance with an embodiment of the present invention, the allowing also includes allowing the target group of spectators to use the MRRD to place bets, including over and under ones, about aspects of a motorsport race chosen from the group consisting of the driver who had the lead for the most laps, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.

In accordance with an embodiment of the present invention, the acquiring includes using a communication subsystem with at least one sensor for real-time data acquisition of motorsport races.

In accordance with an embodiment of the present invention, the selecting step is based upon predetermined criteria that include at least one of geographical location, user preferences, and user demographics.

In accordance with an embodiment of the present invention, the allowing step allows the target group of spectators to place parimutuel wagers on the finish order.

An embodiment of the present invention relates to a system for enhancing spectator engagement during an auction, the system configured for use in relation to an auction conducted by an auction house, the auction including at least one offer to bidders of an item for sale and at least one unknown outcome for the at least one offer, the auction producing a known outcome (there may or may not be a winning bid), the system configured for identifying the at least one unknown outcome to a target group prior to the bidding and for reporting to the target group of spectators the known outcome at conclusion of the bidding, the system further configured for assessing a level of spectator engagement with the auction prior to the conclusion of the bidding.

The system also includes a communication subsystem configured to acquire auction-related data (ARD) associated with the auction, the ARD including the at least one offer of the item for sale and the at least one unknown outcome for the item for sale; (ARD comes from various auctions). In addition, the system includes a targeting module configured to select a target group of spectators based on predetermined criteria. Further, the system includes a transmission module configured to transmit the acquired ARD to the target group of spectators. Furthermore, the system includes an engagement module allowing the target group of spectators to interact with the auction by using the ARD, the engagement module measuring the level of spectator engagement.

In accordance with an embodiment of the present invention, the engagement module measures the level of spectator engagement by offering wagers to the target group of spectators and collecting wagers from the target group of spectators.

In accordance with an embodiment of the present invention, the system further includes an allocation module configured to designate and transmit to the auction house a portion of the wagers.

In accordance with an embodiment of the present invention, the engagement module provides to the target group of spectators, prior to the bidding, an estimated successful bid amount.

In accordance with an embodiment of the present invention, the engagement module provides to the target group of spectators, during the bidding, at least one update to the estimated successful bid amount.

In accordance with an embodiment of the present invention, the engagement module offers wagers to the target group of spectators based on the estimated successful bid amount.

In accordance with an embodiment of the present invention, the ARD acquired by the communication subsystem includes information related to the item for sale, such as description, an estimated successful bid amount, and current bid status.

In accordance with an embodiment of the present invention, the targeting module selects the target group of spectators based on predetermined criteria, including user preferences, user demographics, and previous betting behavior.

In accordance with an embodiment of the present invention, the system further includes a data processing module configured to analyze the ARD and provide real-time successful-bid odds during the auction based on the analyzed data, including an estimated success bid amount for the at least one item and bid histories.

In accordance with an embodiment of the present invention, the engagement module allows the target group of spectators to place bets on the successful-bid amount in real-time, with the option to alter their bets during the auction.

In accordance with an embodiment of the present invention, the auction is chosen from the group consisting of automobiles, motorcycles, watercraft, aircraft, furniture, real estate, art, antiquities, jewelries, fire arms, animals (horses, bulls), and collectibles (define collectibles in the spec).

An embodiment of the present invention relates to a method for enhancing spectator experience during an auction. The method includes the steps of acquiring auction-related data (ARD) associated with the auction and an estimated successful bid amount using a communication subsystem, selecting a target group of spectators based on predetermined criteria, transmitting the acquired ARD to the target group of spectators and allowing the target group of spectators to interact with the auction by using the ARD to place bets associated with auction-bid outcomes.

In accordance with an embodiment of the present invention, the acquired ARD includes information related to auction items, such as descriptions, values, and current bid status. (must include previous and other auction results)

In accordance with an embodiment of the present invention, the step of selecting the target group of spectators is based on predetermined criteria, including user preferences, user demographics, and previous betting behavior.

In accordance with an embodiment of the present invention, the method further includes the step of analyzing the ARD analyze the ARD and provide real-time successful-bid odds based on the analyzed data, including current auction item values and bid histories.

In accordance with an embodiment of the present invention, the step of allowing the target group of spectators to place bets on the successful-bid amount in real-time, with the option to increase their bets during the auction.

In accordance with an embodiment of the present invention, the auction is chosen from the group consisting of automobiles, motorcycles, watercraft, aircraft, furniture, real estate, art, antiquities, jewelry, firearms, animals (horses, bulls), and collectibles.

An embodiment of the present invention relates to a system for use in relation to an animal event produced by an event producer, the animal event occurring between a beginning time and a completion time and producing one or more categories of interim outcomes between the beginning time up to the completion time, wherein the interim outcomes are unknown prior to the beginning time, the system configured for identifying the one or more categories of interim outcomes to a target group of spectators, the system further configured for reporting to the target group of spectators in a period between the beginning time and the completion time the interim outcomes as they become known during the event, and for measuring a level of spectator engagement with the event, the system, the system configured for enhancing spectator experience during the animal event.

The system also includes a communication subsystem configured to acquire animal-event-related data (AERD) for the animal event, the AERD including the one or more categories of interim outcomes before the beginning time of the event and the interim outcomes as they become known during the event. In addition, the system includes a targeting module configured to select a target group of spectators based on a predetermined criterion. Further, the system includes a transmission module configured to transmit the acquired AERD to the target group of spectators before the beginning time of the animal event and during the animal event and an engagement module allowing the target group of spectators to interact with the animal event by using the AERD, the engagement module measuring the level of spectator engagement.

In accordance with an embodiment of the present invention, the system further includes a wager offering module configured to offer wagers to the target group of spectators on interim outcomes between the beginning time and the completion time.

In accordance with an embodiment of the present invention, the engagement module allows for the target group of spectators to place wagers between the beginning time and the completion time on one or more of the interim outcomes.

In accordance with an embodiment of the present invention, the engagement module measures the level of spectator engagement.

In accordance with an embodiment of the present invention, the system further includes an allocation module configured to designate and transmit to the event producer a portion of the wagers.

In accordance with an embodiment of the present invention, the system further includes a data-processing module configured to analyze the AERD and provide real-time odds for betting on animal-event outcomes based on the analyzed data.

In accordance with an embodiment of the present invention, the communication subsystem further comprises one or more sensors for real-time data acquisition of the animal event.

In accordance with an embodiment of the present invention, the predetermined criteria for selecting the target group of spectators includes at least one of geographical location, user preferences, and user demographics.

In accordance with an embodiment of the present invention, the engagement module enables the target group of spectators to place bets on interim outcomes for the animal events, the interim outcomes chosen from the group consisting of final times and other data pertinent to animals, animal-trainers, animal-riders in a rodeo, and specific event outcomes other than final times.

In accordance with an embodiment of the present invention, a two-way communication is established between the animal event and the spectator, wherein the two-way communication allows the spectator to have an increased level of spectator engagement during the event.

In accordance with an embodiment of the present invention, the animal event is chosen from the group consisting of rodeos, stock shows, bullfights, and circuses.

An embodiment of the present invention relates to a method for enhancing spectator experience during an animal event. The method includes the steps of acquiring animal-event-related data (AERD) for the animal event using a communication subsystem, selecting a target group of spectators based on predetermined criteria, transmitting the acquired AERD to the target group of spectators and allowing the target group of spectators to engage with the animal event by using the AERD to place bets about animal-event outcomes.

In accordance with an embodiment of the present invention, the method further includes real-time analysis of the AERD which provides updated odds for betting to the target group of spectators.

In accordance with an embodiment of the present invention, the predetermined criteria for selecting the target group of spectators includes at least one of geographical location, user preferences, and user demographics.

In accordance with an embodiment of the present invention, the step of allowing the target group of spectators to engage with the animal event includes placing bets on various animal-event outcomes, including final times and other data pertinent to animals, animal-trainers, animal-riders in a rodeo, and specific game and domesticated animal events.

In accordance with an embodiment of the present invention, all the AERD is amalgamated into a standardized date format to enable transmission through plural third parties involved in betting.

In accordance with an embodiment of the present invention, the animal event is chosen from the group consisting of rodeos, stock shows, bullfights, and circuses.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description merely show some embodiments of the present disclosure, and a person of ordinary skill in the art can derive other implementations from these accompanying drawings without creative efforts. All of the embodiments or the implementations shall fall within the protection scope of the present disclosure. Having thus described the disclosure in general terms, reference will now be made to the accompanying figures.

FIG. 1 is a flowchart illustrating a system 100 for enhancing spectator experience during an event, in accordance with an embodiment of the present invention.

FIG. 2 is a block diagram 200 illustrating communication between an event and a group of spectators through the system 100, in accordance with an exemplary embodiment of the present invention.

FIG. 3 is a block diagram 300 illustrating a wager offering module 502 configured to offer wagers to the plurality of spectators 206 on interim outcomes, in accordance with an embodiment of the present invention.

FIG. 4 is a block diagram illustrating a method 400 for enhancing the spectator experience during an event, in accordance with an embodiment of the present invention.

FIG. 5 is a flow chart illustrating a system 500 for use in relation to a motorsport race produced by an event producer, in accordance with an embodiment of the present invention.

FIG. 6 is a block diagram 600 illustrating communication between motorsport race 602 and a plurality of spectators 606 through the system 500, in accordance with an exemplary embodiment of the present invention.

FIG. 7 illustrates a diagrammatic representation 700 illustrating a data processing module 702 configured to amalgamate and reformat the MRRD, in accordance with an embodiment of the present invention.

FIG. 8 is a block diagram illustrating a method 800 for enhancing the spectator experience during a motorbike race, in accordance with an embodiment of the present invention.

FIG. 9 is a flow chart 900 illustrating a system for enhancing spectator experience during an auction, in accordance with an embodiment of the present invention.

FIG. 10 is a diagrammatic representation 1000 of the engagement module 908 associated with the system 900, in accordance with an exemplary embodiment of the present invention.

FIG. 11 is a diagrammatic representation 1100 of an allocation module 1102 associated with the system 900, in accordance with an exemplary embodiment of the present invention.

FIG. 12 is a diagrammatic representation 1200 illustrating the targeting module 904 associated with the system 900, in accordance with an exemplary embodiment of the present invention.

FIG. 13 is a flow chart 1300 illustrating a method for enhancing the spectator experience during an auction, in accordance with an embodiment of the present invention.

FIG. 14 is a block diagram illustrating a system 1400 for enhancing spectator experience during an animal event produced by an event producer, in accordance with an embodiment of the present invention.

FIG. 15 is a diagrammatic representation of a wager offering module 1502 configured to offer wagers to a target group of spectators 1506 on interim outcomes between the beginning time and the completion time.

FIG. 16 is a diagrammatic representation 1600 of the targeting module 1404 associated with the system 1400, in accordance with an embodiment of the present invention.

FIG. 17 is a block diagram illustrating a method 1700 for enhancing the spectator experience during an animal event, in accordance with an embodiment of the present invention.

It should be noted that the accompanying figures are intended to present illustrations of a few examples of the present disclosure. The figures are not intended to limit the scope of the present disclosure. It should also be noted that the accompanying figures are not necessarily drawn to scale.

### DETAILED DESCRIPTION OF THE INVENTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

The accompanying drawing is used to help easily understand various technical features and it should be understood that the alternatives presented herein are not limited by the accompanying drawing. As such, the present disclosure should be construed to extend to any alterations, equivalents and substitutes in addition to those which are particularly set out in the accompanying drawing. Although the terms first, second, etc. may be used herein to describe various elements or values, these elements or values should not be limited by these terms. These terms are generally only used to distinguish one element or values from another.

It will be apparent to those skilled in the art that other alternatives of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific aspect, method, and examples herein. The invention should therefore not be limited by the above described alternative, method, and examples, but by all aspects and methods within the scope of the invention. It is intended that the specification and examples be considered as exemplary, with the true scope of the invention being indicated by the claims.

Conditional language used herein, such as, among others, “can,” “may,” “might,” “may,” “e.g.,” unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having” are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

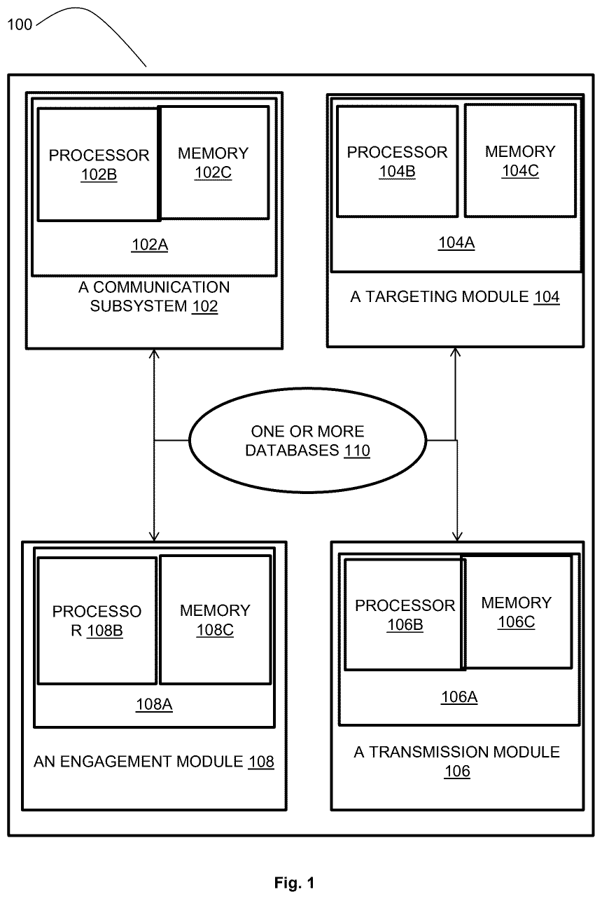

FIG. 1 is a flowchart illustrating a system 100 for enhancing spectator experience during an event, in accordance with an embodiment of the present invention. The system 100 may be produced by an event producer for use in relation to the event. In an embodiment of the present invention, the event may be any of but not limited to a motorsports race, an animal event, a car race, and an auction. In addition, the event may occur between a beginning time up to the end time and may produce one or more categories of interim outcomes between the beginning time up to the end time. The interim outcomes may be unknown prior to the beginning time.

In an embodiment of the present invention, the system 100 may be configured to identify the one or more categories of interim outcomes to a target group of spectators. In addition, the system 100 may be configured to report to the target group of spectators in a period between the beginning time and the end time the interim outcomes as they become known during the event. Further, the system 100 may measure a level of spectator engagement with the event.

In a specific embodiment of the present invention, the system 100 may include a communication subsystem 102, a targeting module 104, a transmission module 106 and an engagement module 108. Other embodiments of the present invention may or may not include other modules to describe the invention.

In an embodiment of the present invention, the communication subsystem 102 may be configured to acquire event-related data (ERD) for the event. The ERD may include the one or more categories of interim outcomes before the beginning time of the event and the interim outcomes as they become known during the event.

In an embodiment of the present invention, the communication subsystem 102 may include a control subsystem 102a. The control subsystem 102a may include a processor 102b, at least one database 110 and a computer readable memory 102c including a processor-readable instruction that is executed by the processor 102b and cause the processor 102b to acquire the event-related data (ERD) for the event. The computer readable memory 102c in the control subsystem 102a may be used to store the ERD.

The processor 102b associated with the control subsystem 102a may be any well-known processor, but not limited to processors from Intel Corporation. Alternatively, the processor may be a dedicated controller such as an ASIC or ARM, MIPS, SPARC, or INTEL® IA-32 microcontroller.

Similarly, in yet another embodiment of the present invention, the processor 102b may comprise a collection of processors which may or may not operate in parallel. The processor 102b may be any processor-driven device, such as may include one or more microprocessors and memories or other computer-readable media operable for storing and executing computer-executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 102b may execute any set of instructions directly as computer executable codes or indirectly (such as scripts). In that regard, the terms “instructions,” and “steps” may be used interchangeably herein. The instructions may be stored in object code form for direct processing by the processor 102b, or in any other computer language including scripts or collections of independent source code modules that are interpreted on demand or compiled in advance.

In accordance with an embodiment of the present invention, the computer readable memory 102c is configured with the processor 102b for storing the ERD. For example, the computer readable memory 102c may store software used by a user interface or the processor, such as an operating system (not shown), application programs (not shown), and an associated internal database (not shown).

In addition, the computer readable memory 102c associated with the control subsystem 102a stores instructions to be executed by the control subsystem 102a. The computer readable memory 120c can be any type of suitable memory, including various types of dynamic random-access memory (DRAM) such as SDRAM, various types of static RAM (SRAM), and various types of non-volatile memory (PROM, EPROM, and flash). It should be understood that the computer readable memory 102c may be a single type of memory component or it may be composed of many different types of memory components. As noted above, the computer readable memory 102c stores instructions for executing one or more methods for enhancing spectator experience during an event. For example, the computer readable memory may store software used by the user device, such as an operating system (not shown), application programs (not shown), and an associated internal database (not shown). In an alternative embodiment, the computer readable memory 102c may be an external memory to the control subsystem 102a to store various data and computer executable instructions.

In some embodiments, the computer readable memory 102c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 102c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, electrostatic storage devices such as solid-state drives.

In an embodiment of the present invention, the communication subsystem 102 may include one or more sensors (not shown in figures) for real-time data acquisition of the event. In an example, the one or more sensors may be placed to monitor conditions such as temperature, humidity and wind speed, climate condition, air condition, air quality, air index, moisture level of the place where the event is held. In accordance with an embodiment of the present invention, the data from the one or more sensors is transmitted to the target group of spectators.

In an embodiment of the present invention, the communication subsystem 102 may be configured to acquire transmission signals of live events, chosen from the group consisting of broadcast and streaming signals. In an exemplary embodiment, the communication subsystem 102 may be wired or wireless. The wired communication may include any of but not limited to landline phones which uses copper wires transmit voice signals and fibre-optic communication which transmits data using light signals through optical fibres. The wireless communication may include but not limited to Wi-Fi which may allow devices to connect through the internet and communicate wirelessly and Bluetooth which may be used for short-range connections between devices like headphones and smart phones. In addition, the communication subsystem 102 may be any of but not limited to a plurality of smart phones which use cellular networks to transmit voice, text messages, and data and a plurality of cell towers which use relay signals from the phones to the network.

In another example, the communication subsystem 102 may be a telemetry system which allows for real-time analysis and decision-making during the event in which events equipment are equipped with the telemetry system that continuously transmit ERD (event related data), including performance of a vehicle used in case of a racing event, speed, tire condition, fuel levels of a vehicle, and driver biometrics of a vehicle, back to the team's pit area which allows for real-time analysis and decision-making during the event.

In yet another example, the communication subsystem 102 may include cameras mounted on race cars to capture video footage in case of a racing event, which is streamed to the event control centre and broadcasted to the fans. In yet another example, the communication system 102 may integrate with timing and scoring equipment to provide precise information about lap times, sector times and event positions to teams, race control and spectators in case of a racing event. In yet another example, the communication system 102 may include any of trackside sensors, GPS tracking, race data analysis tools, driver biometrics, team communication networks and data distribution to spectators in the case of racing event. The above-mentioned examples may illustrate that a communication system may be configured to acquire, process, and distribute event-related data (ERD) to various spectators, enhancing the event experience and ensuring the safety and efficiency of the event.

In an embodiment of the present invention, the targeting module 104 may be configured to select the target group of spectators based on a predetermined criterion. In an embodiment of the present invention, the predetermined criteria for selecting the target group of spectators may include at least one of geographical location, user preferences, and user demographics. In another embodiment of the present invention, the predetermined criterion may or may not include other parameters performing similar function.

In an embodiment of the present invention, the targeting module 104 may include a control subsystem 104a. The control subsystem may include a processor 104b, the least one database 110 and a computer readable memory 104c including a processor-readable instruction that may be executed by the processor 104b and may cause the processor 104b to select the target group of spectators based on the predetermined criterion. The computer readable memory 104c in the control subsystem 104a may be used to store the target group of spectators.

In an embodiment of the present invention, the processor 104b, the computer readable memory 104c and the one or more database 110 of the targeting module 104 may be any of the above-mentioned processor, memory and database used for the communication subsystem 102.

In an example, the targeting module 104 may select the target group of spectators by using a ticket type targeting in which different ticket categories can be used as a criterion to tailor messages, offers, and experiences to specific ticket holders. In another example, the targeting module 104 may select the target group of spectators using location-based targeting in which spectators situated in different areas of the event can receive targeted information.

In yet another example, the targeting module 104 may select the target group of spectators by determining their interests, such as favorite teams or drivers in case of a racing event, and deliver updates, statistics, and special content related to those preferences. In yet another example, the targeting module 104 may select the target group of spectators based on engagement level in which spectators who actively engage with the event app or show a high level of interest by checking into different event locations can receive rewards or recognition for their participation.

In an embodiment of the present invention, the targeting module 104 may select the target group of spectators based on user demography in which criteria such as age, gender or language preference can be used to customize content and promotions. For instance, families with children might receive information about kid-friendly activities at the event.

In an embodiment of the present invention, the transmission module 106 is configured to transmit the acquired ERD to the target group of spectators. In an embodiment of the present invention, the transmission module 106 may include a control subsystem 106a. The control subsystem may include a processor 106b, the least one database 110 and a computer readable memory 106c may include a processor-readable instruction that is executed by the processor 106b and may cause the processor 106b to transmit the acquired ERD to the target group of spectators.

In an embodiment of the present invention, the processor 106b, the computer readable memory 106c and the one or more databases 110 of the transmission module 106 may be any of the above-mentioned processors, memory and databases.

In an example, the transmission module 106 may transmit the acquired ERD to the target group of spectators before the beginning time of the event and during the event by delivering real-time commentary, event updates, and announcements to spectators in the stands, providing insights into the event, driver statistics, and event-related news.

In another example, the transmission module 106 may transmit the acquired ERD to the target group of spectators by using live audio where spectators can access live radio broadcasts or audio commentary on their smartphones or portable radios, allowing them to choose their preferred audio feed, including team radio communications.

In yet another example, the transmission module 106 may transmit the acquired ERD to the target group of spectators by providing live event coverage and in-car camera feeds on their smartphones or tablets. Different camera angles and driver-specific feeds can be offered for a more personalized experience.

In yet another example, the transmission module 106 may transmit the acquired ERD by using real-time leader boards and statistics, fan engagements apps, social media feeds, and fan zone information.

In an embodiment of the present invention, the engagement module 108 may allow the target group of spectators to interact with the event by using the ERD, causing the spectators to have an enhanced spectator experience. In an embodiment of the present invention, the enhanced spectator experience caused by the engagement module 108 may be chosen from the group consisting of participants in the event, having an emotional experience during the event, enjoying the event more than they would have without the system, betting on the outcome of the event, or a combination of each of those things. In addition, the engagement module 108 may measure the level of spectator engagement in the event.

In an embodiment of the present invention, the engagement module 108 may allow for the target group of spectators to place wagers between the beginning time and the end time on one or more of the interim outcomes. In addition, the engagement module 108 may measure the level of spectator engagement based at least in part from the wagers placed by the target group of spectators.

The engagement module 108 may measure the level of spectator engagement based on at least one factor chosen from the group consisting of participating in the event, having an emotional experience during the event, enjoying the event more than they would have without the system, betting on the outcome of the event, or a combination of each of those things. Further, the engagement module 108 may enable the target group of spectators to place bets on various event outcomes chosen from the group consisting of final times, final scores, driver statistics, player statistics, specific race events, and specific game events.

In an embodiment of the present invention, the system 100 may further include a data processing module configured to analyze the ERD and provide real-time odds for betting on the event outcome based on the analyzed data. In an embodiment of the present invention, the system 100 may establish a two-way communication between the event and the spectator. The two-way communication allows the spectator to have enhanced engagement with the event.

In an embodiment of the present invention, the engagement module 108 includes a control subsystem 108a. The control subsystem 108a may include a processor 108b, the least one database 110 and a computer readable memory 108c including a processor-readable instruction that is executed by the processor 108b and may cause the processor 108b to interact with the event by using the ERD, causing the spectators to have an enhanced spectator experience.

In an embodiment of the present invention, the processor 108b, the computer readable memory 108c and the one or more database 110 of the engagement module 108 may be any of the above-mentioned processor, memory and database used for the communication subsystem 102.

In an embodiment of the present invention, the engagement module 108 may enable the target group of spectators to place bets on various event outcomes chosen from the group consisting of final times or results, final scores, driver statistics, participant statistics, specific race events, and specific game events.

In an example, a dedicated mobile app may allow spectators to place wagers on various race outcomes, such as the winner, podium winner, podium finishers, fastest lap, or the number of safety car period. In another example, the engagement module 108 may allow interaction of the target group of spectators by providing a live betting platform where spectators can use a real-time betting platform to make dynamic wagers during the event, adjusting their bets as the event unfold.

In yet another example, the engagement module 108 may allow interaction of the target group of spectators providing driver performance betting such in which wagers can be placed on individual driver performance, such as predicting the number of overtakes, the driver with the most laps led, or who will finish as the top-ranked driver for a particular team. In yet another example, the engagement module 108 may allow participation of the target group of spectators by using championship betting, safety car betting, driver head-to-head betting, live betting challenges, in race betting contests, and social betting pools.

In an embodiment of the present invention, the system 100 may include a wager offering module configured to offer wagers to the target group of spectators on interim outcomes between the beginning time and the end time.

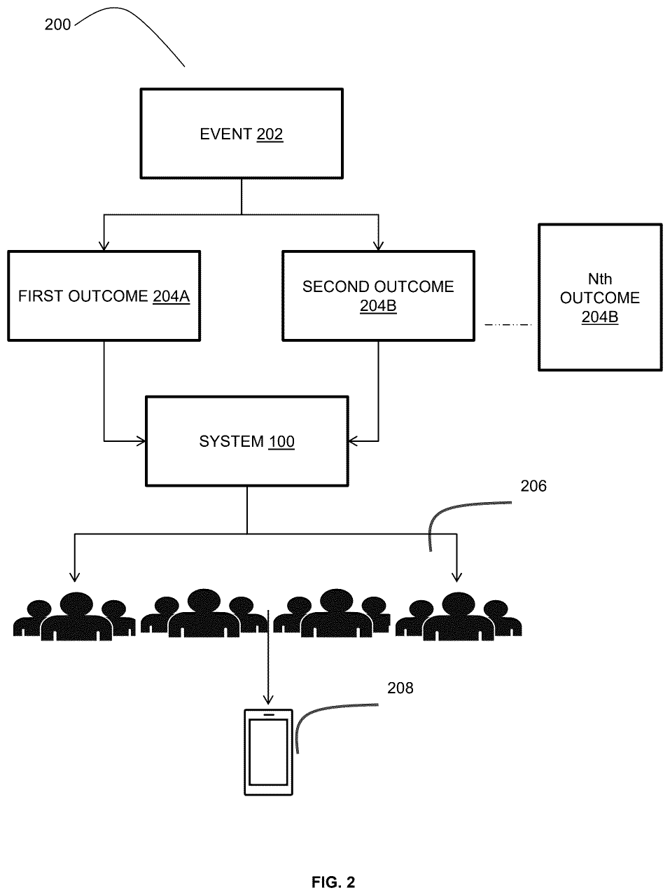

FIG. 2 is a block diagram 200 illustrating the communication between an event 202 and a group of spectators 206 through the system 100, in accordance with an exemplary embodiment of the present invention. The event may include “n” outcomes, where n is a natural number. In an example, the event may include a first outcome 204a and a second outcome 204b.

In an embodiment of the present invention, the system 100 may provide wagers to the plurality of spectators 206 to engage with the event 202. The plurality of spectators participates in the event 202 by applying on the outcomes of the event, where the outcome may be the first outcome 204a, the second outcome 204b up to the nth outcome of the event 202.

In an embodiment of the present invention, the plurality of spectators 206 may receive ongoing statistics related to the outcomes of the event 202 on their mobile phones 208. The mobile phones 208 may allow the plurality of spectators 206 to communicate with the event 202 through the mobile phone 208. The communication between the plurality of spectators 206 and the event 202 may be a two-way communication which enhances the event engagement.

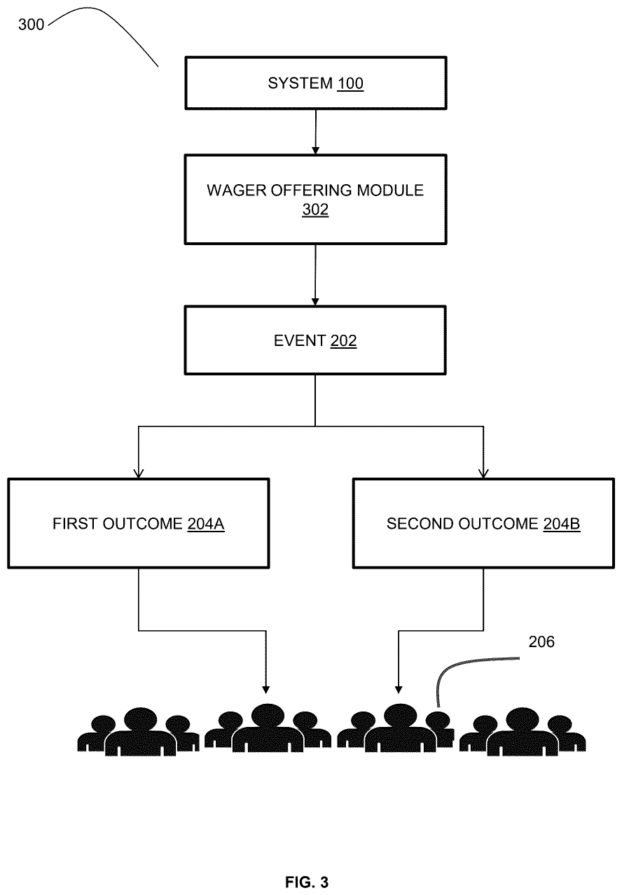

FIG. 3 is a block diagram 300 illustrating a wager offering module 502 configured to offer wagers to the plurality of spectators 206 on interim outcomes between the beginning time and the end time, in accordance with an embodiment of the present invention (References have been made to FIG. 1 and FIG. 2).

In an embodiment of the present invention, the wager offering module 502 may be associated with the system 100. In an example, the event 202 has one or more outcomes which may include any of but may not be limited to the first outcome 204a and the second outcome 204b. In addition, the wager offering module 502 may enhance engagement of the plurality of spectators 206 with the event 202 by offering wagers on the one or more outcomes of the event 202.

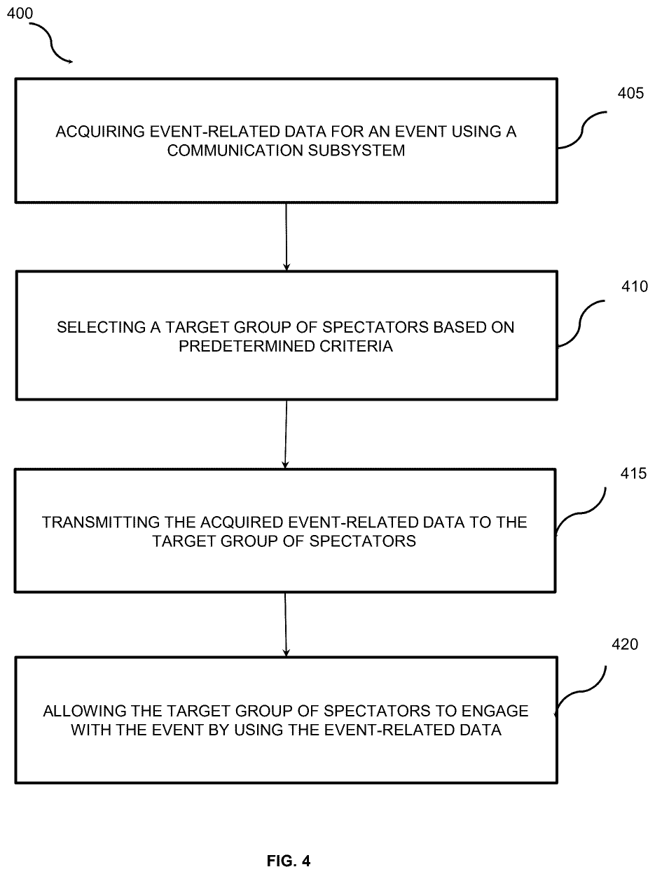

FIG. 4 is a block diagram illustrating a method 400 for enhancing the spectator experience during an event, in accordance with an embodiment of the present invention. In one specific embodiment, the flow chart 400 may include steps to illustrate the method for enhancing the spectator experience during the event. Other embodiments may include other steps to illustrate similar method.

In an embodiment of the present invention, the method may initiate at step 405 and terminates at step 420. At step 405, the method 400 may include acquiring an event-related data (ERD) for the event using a communication subsystem 102. (References have been made to FIG. 1)

At step 410, a target group of spectators may be selected based on a predetermined criterion. In an embodiment of the present invention, the predetermined criteria for selecting the target group of spectators may include at least one of geographical location, user preferences, and user demographics. In another embodiment of the present invention, the predetermined criteria may or may not include other parameters performing similar function.

At step 415, the acquired ERD may be transmitted to the target group of spectators. At step 220, the target group of spectators may be allowed to engage with the event by using the ERD, causing the spectators to have an enhanced spectator experience. In an embodiment of the present invention, the enhanced spectator experience caused by the allowing step 420 may be chosen from the group consisting of participants in the event. The participants may have an emotional experience during the event, enjoying the event more than they would have without the system 100, betting on the outcome of the event, or a combination of each of those things.

In an embodiment of the present invention, the step 420 of allowing the target group of spectators to engage with the event may include placing wagers on various event outcomes chosen from the group consisting of final times, final scores, driver statistics, player statistics, specific race events, and specific game events. In another embodiment of the present invention, the group of various event outcomes may include any other parameters relates to a specific game.

In an embodiment of the present invention, the method 400 further includes real-time analysis of the ERD to provide updated odds for betting to the target group of spectators. In an embodiment of the present invention, all the ERD may be amalgamated into a standardized data format to enable transmission through a plurality of third parties involved in the event.

In an exemplary embodiment of the present invention, a computer-readable medium may include computer-executable instructions for implementing the method for enhancing spectator experience during an event. In an example, the computer readable medium may be any of but not limited to a memory card which can store software and instructions, CD-ROM that can be read by a computer's optical drive, DVD, USB Flash Drive, Hard Disk Drive to store both data and execute instructions, Solid State Drive, Magnetic Tape, Cloud Storage in which files and instructions are stored like Google Drive or drop box, network storage, remote repositories, ROM, EPROM and EEPROM.

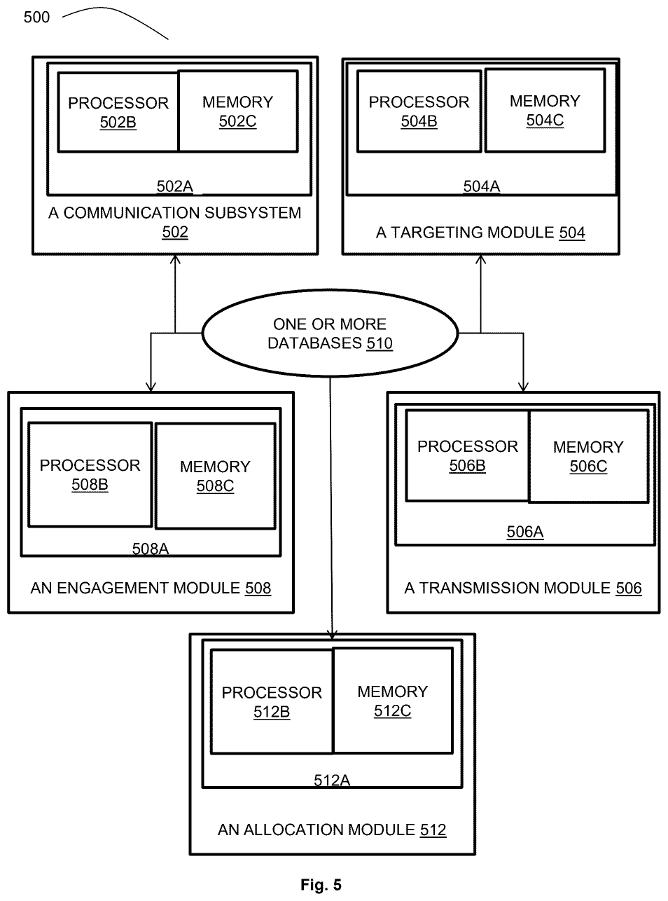

FIG. 5 is a flow chart illustrating a system 500 for use in relation to a motorsport race produced by an event producer, in accordance with an embodiment of the present invention. The system 500 may be configured for collecting wagers from a betting populace and for allocating a portion of the wagers as revenue to the event producer and for enhancing experience of a plurality of spectators during a motorsport race. In a specific embodiment, the system 500 may include a communication subsystem 502, a targeting module 504, a transmission module 506, an engagement module 508, an allocation module 512 and one or mor databases 510. Other embodiments of the present invention may or may not include other modules to describe the invention.

In an embodiment of the present invention, the communication subsystem 502 may be configured to acquire motorsport race-related data (MRRD) for the motorsport race. In an embodiment of the present invention, the communication subsystem 502 may include a control subsystem 502a. The control subsystem 502a may include a processor 502b, at least one database 510 and a computer readable memory 502c which may include a processor-readable instruction that is executed by the processor 502b and may cause the processor 502b to acquire the motorsport race-related data (MRRD) for the motorsport race. The computer readable memory 502c in the control subsystem 502a may be used to store the MRRD.

The processor 502b may be associated with the control subsystem 502a may be any well-known processor, but may not be limited to processors from Intel Corporation. Alternatively, the processor 502b may be a dedicated controller such as an ASIC or ARM, MIPS, SPARC, or INTEL® IA-32 microcontroller.

Similarly, in yet another embodiment of the present invention, the processor 502b may comprise a collection of processors which may or may not operate in parallel. The processor 502b may be any processor-driven device, such as may include one or more microprocessors and memories or other computer-readable media operable for storing and executing computer-executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 502b may execute any set of instructions directly as computer executable codes or indirectly (such as scripts). In that regard, the terms “instructions,” and “steps” may be used interchangeably herein. The instructions may be stored in object code form for direct processing by the processor 502b, or in any other computer language including scripts or collections of independent source code modules that are interpreted on demand or compiled in advance.

In accordance with an embodiment of the present invention, the computer readable memory 502c may be configured with the processor 502b for storing the ERD. For example, the computer readable memory 502c may store software used by a user interface or the processor 502b, such as an operating system (not shown), application programs (not shown), and an associated internal database (not shown).

In addition, the computer readable memory 502c may be associated with the control subsystem 502a stores instructions to be executed by the control subsystem 502a. The computer readable memory 502c may be any type of suitable memory, including various types of dynamic random-access memory (DRAM) such as SDRAM, various types of static RAM (SRAM), and various types of non-volatile memory (PROM, EPROM, and flash). The computer readable memory 502c may be a single type of memory component or it may be composed of many different types of memory components. As noted above, the computer readable memory 502c stores instructions for executing one or more methods for enhancing spectator experience during the race. For example, the computer readable memory 502c may store software used by the user device, such as an operating system (not shown), application programs (not shown), and an associated internal database (not shown). In an alternative embodiment, the computer readable memory 502c may be an external memory to the control subsystem 502a to store various data and computer executable instructions.

In some embodiments, the computer readable memory 502c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 502c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, and electrostatic storage devices such as solid-state drives.

In an embodiment of the present invention, the communication subsystem 502 may include one or more sensors (not shown in figures) for real-time data acquisition of the motorsport race. In an example, the one or more sensors may be placed around the racetrack to monitor environmental conditions such as temperature, humidity and wind speed, track condition such as grip levels and debris, safety status. In accordance with an embodiment of the present invention, the data from the one or more sensors may be transmitted to the plurality of spectators.

In an embodiment of the present invention, the communication subsystem 502 may be configured to acquire transmission signals of live motorsport races, chosen from the group consisting of broadcast and streaming signals. In an example, the communication subsystem 502 may be wired or wireless. The wired communication includes but not limited to landline phones which uses copper wires transmit voice signals and fibre-optic communication which transmits data using light signals through optical fibres. The wireless communication includes but not limited to Wi-Fi which allows devices to connect through the internet and communicate wirelessly and Bluetooth which is used for short-range connections between devices like headphones and smart phones. In addition, the communication subsystem 502 may be any of but not limited to a plurality of smart phones which use cellular networks to transmit voice, text messages, and data and a plurality of cell towers which use relay signals from the phones to the network.

In another example, the communication subsystem 502 may be a telemetry system which allows for real-time analysis and decision-making during the race. in which race cars are equipped with the telemetry system that continuously transmit MRRD, including engine performance, speed, tire condition, fuel levels, and driver biometrics, back to the team's pit area which allows for real-time analysis and decision-making during the race.

In yet another example, the communication subsystem 502 may include cameras mounted on race cars to capture video footage, which is streamed to the race control centre and broadcasted to the fans. In yet another example, the communication system 502 may integrate with timing and scoring equipment to provide precise information about lap times, sector times and race positions to teams, race control and spectators. In yet another example, the communication system 502 may include any of trackside sensors, GPS tracking, race data analysis tools, driver biometrics, team communication networks and data distribution to spectators. The above-mentioned examples illustrate that a communication system can be configured to acquire, process, and distribute motorsport race-related data (MRRD) to various spectators, enhancing the racing experience and ensuring the safety and efficiency of motorsport events.

In an embodiment of the present invention, the targeting module 504 may be configured to select a target group of spectators from the plurality of spectators based on a predetermined criterion. In an embodiment of the present invention, the targeting module 504 may include a control subsystem 504a. The control subsystem includes a processor 504b, the least one database 510 and a computer readable memory 504c which includes a processor-readable instruction that is executed by the processor 504b and causes the processor 504c to select the target group of spectators based on the predetermined criterion. The computer readable memory 504c in the control subsystem is used to store the target group of spectators.

In an embodiment of the present invention, the processor 504b, the computer readable memory 504c and the one or more database 510 of the targeting module 504 may be any of the above-mentioned processors, memory and databases used for explaining the communication subsystem 502.

In an embodiment of the present invention, the predetermined criteria for selecting the target group of spectators includes at least one of geographical location, user preferences, and user demographics. In another embodiment of the present invention, the predetermined criterion may or may not include other parameters performing similar function.

In an example, the targeting module 504 may select the target group of spectators by using a ticket type targeting in which different ticket categories can be used as a criterion to tailor messages, offers, and experiences to specific ticket holders. In another example, the targeting module 504 may select the target group of spectators using location-based targeting in which spectators situated in different areas of the racetrack can receive targeted information.

In yet another example, the targeting module 504 may select the target group of spectators by determining their interests, such as favorite racing teams or drivers, and deliver updates, statistics, and special content related to those preferences. In yet another example, the targeting module 504 may select the target group of spectators based on engagement level in which spectators who actively engage with the race even app or show a high level of interest by checking into different race locations can receive rewards or recognition for their participation.

In an embodiment of the present invention, the targeting module 504 may select the target group of spectators based on user demography in which criteria such as age, gender or language preference can be used to customize content and promotions. For instance, families with children might receive information about kid-friendly activities at the motorsport race.

In an embodiment of the present invention, the transmission module 506 may be configured to transmit the acquired ERD to the target group of spectators. In an embodiment of the present invention, the transmission module 506 includes a control subsystem 506a. The control subsystem may include a processor 506b, at least one database and 510 a computer readable memory 506c including a processor-readable instruction that is executed by the processor 506b and causes the processor 506b to transmit the acquired ERD to the target group of spectators.

In an embodiment of the present invention, the processor 506b, the computer readable memory 506c and the one or more database of the transmission module 506 may be any of the above-mentioned processor, memory and database used for the transmission module 506.

In an example, the transmission module 506 transmits the acquired ERD to the target group of spectators by delivering real-time commentary, race updates, and announcements to spectators in the stands, providing insights into the race, driver statistics, and event-related news.

In another example, the transmission module 506 may transmit the acquired ERD to the target group of spectators by using live audio where spectators can access live radio broadcasts or audio commentary on their smart phones or portable radios, allowing them to choose their preferred audio feed, including team radio communications.

In yet another example, the transmission module 506 may transmit the acquired ERD to the target group of spectators by providing live race coverage and in-car camera feeds on their smart phones or tablets. Different camera angles and driver-specific may feed can be offered for a more personalized experience.

In yet another example, the transmission module 506 may transmit the acquired ERD by using real-time leader boards and statistics, fan engagements apps, social media feeds, and fan zone information.

In an embodiment of the present invention, the engagement module 508 may allow the target group of spectators to interact with the motorsport race by using the MRRD to place parimutuel wagers about motorsport race outcomes. In an embodiment of the present invention, the engagement module 508 may include a control subsystem 508a. The control subsystem 508a includes a processor 508b, the least one database 510 and a computer readable memory 508c including a processor-readable instruction that is executed by the processor 508b and cause the processor 508c to interact with the motorsport race by using the MRRD, causing the spectators to have an enhanced spectator experience.

In an embodiment of the present invention, the processor 508b, the computer readable memory 508c and the one or more database 510 of the engagement module 508 may be any of the above-mentioned processor, memory and database used for explaining the communication subsystem 502.

In an embodiment of the present invention, the enhanced spectator experience may cause by the engagement module 508 is chosen from the group consisting of participants in the motorsport race, having an emotional experience during the motorsport race, enjoying the motorsport race more than they would have without the system 500, betting on the outcome of the motorsport race, or a combination of each of those things.

In an embodiment of the present invention, the engagement module 508 may allow the target group of spectators to interact with the motorsport race by placing pari-mutuel wagers on race outcomes which adds excitement and engagement to the motorsport race. In an example, a dedicated mobile app may allow spectators to place wagers on various race outcomes, such as the winner, podium winner, podium finishers, fastest lap, or the number of safety car period.

In another example, the engagement module 508 may allow interaction of the target group of spectators by providing a live betting platform where spectators can use a real-time betting platform to make dynamic wagers during the race, adjusting their bets as the race unfold.

In yet another example, the engagement module 508 may allow interaction of the target group of spectators providing driver performance betting such in which wagers can be placed on individual driver performance, such as predicting the number of overtakes, the driver with the most laps led, or who will finish as the top-ranked driver for a particular team. In yet another example, the engagement module 508 allows participation of the target group of spectators by using championship betting, safety car betting, driver head-to-head betting, and live betting challenges, in race betting contests, and social betting pools.

In an embodiment of the present invention, the system 500 may establish a two-way communication between the motorsport race and the spectator. The two-way communication allows the spectator to have enhanced engagement with the motorsport race.

In an embodiment of the present invention, the engagement module 508 may enable the target group of spectators to place parimutuel wagers on the finish order. In addition, the engagement module 508 may be configured to allow the target group of spectators to use the MRRD to place bets, including over and under ones, about aspects of a motorsport race chosen from the group consisting of the driver who had the lead for the most laps, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.

In an embodiment of the present invention, the system 500 further includes a data processing module configured to amalgamate and reformat the MRRD into a standardized data feed that is receivable by parimutuel platforms that provide real-time odds for betting based upon the analysed data.

In an embodiment of the present invention, the allocation module 512 may be configured to designate and transmit to the event producer a portion of the parimutuel wagers. The allocation module 512 may include a control unit 512a, a processor 512b, a memory 512c and the one or more databases 512.

In an embodiment of the present invention, the processor 508b, the computer readable memory 508c and the one or more database 510 of the engagement module 508 may be any of the above-mentioned processor, memory and database used for explaining the communication subsystem 502.

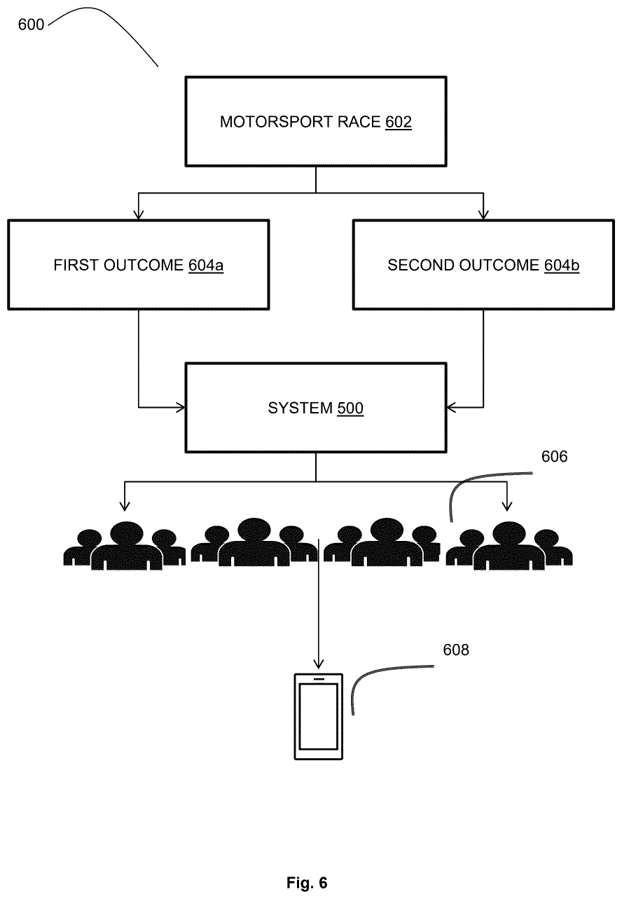

FIG. 6 is a block diagram 600 illustrating the communication between motorsport race 602 and a plurality of spectators 606 through the system 500, in accordance with an exemplary embodiment of the present invention. The event may include “n” outcomes, where n is a natural number. In an example, the event may include a first outcome 604a and a second outcome 604b.

In an embodiment of the present invention, the system 500 may provide wagers to the plurality of spectators 606 to engage with the motorsport race 602. The plurality of spectators 606 participates in the motorsport race 602 by applying on the outcomes of the motorsport race, where the outcome may be the first outcome 604a, the second outcome 204b up to the nth outcome of the motorsport race 602.

In an embodiment of the present invention, the plurality of spectators 606 may receive ongoing statistics related to the outcomes of the motorsport race 602 on their mobile phones 608. The mobile phones 608 may allow the plurality of spectators 606 to communicate with the motorsport race 602 through the mobile phone 608. The communication between the plurality of spectators 606 and the event 602 may be a two-way communication which enhances the motorsport race engagement.

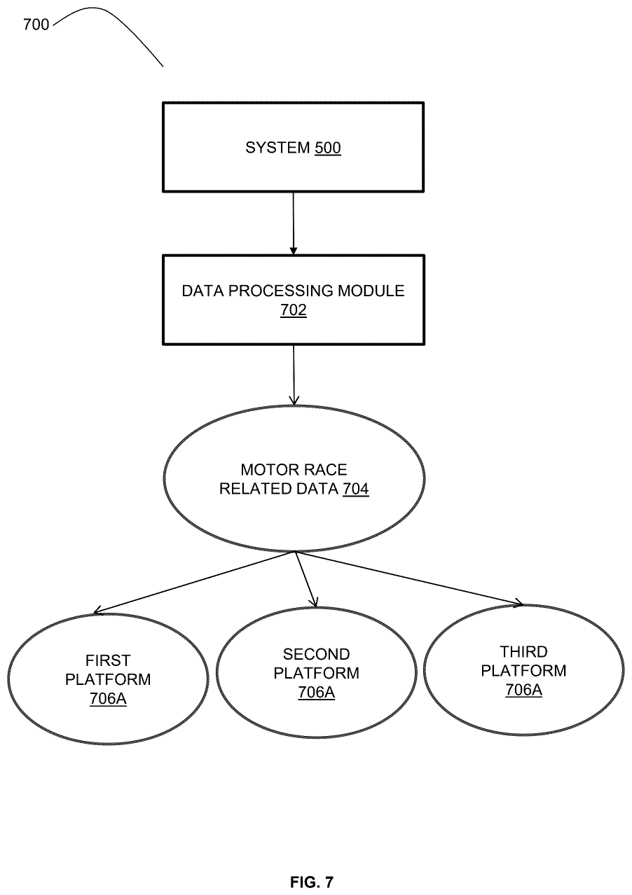

FIG. 7 illustrates a diagrammatic representation 700 illustrating a data processing module 702 configured to amalgamate and reformat the MRRD, in accordance with an embodiment of the present invention. The MRRD is amalgamated and reformatted into a standardized data feed that is receivable by a plurality of parimutuel platforms that provide real-time odds for betting based upon the analysed data, in an exemplary embodiment of the present invention.

In an embodiment of the present invention, the plurality of parimutuel platforms that may receive the standardized data feed associated with the motorbike race related data include a first platform 706a, a second platform 706b, a third platform 706c and so on.

In an embodiment of the present invention, the first platform 706a may be a dedicated parimutuel platform designed to receive and process the standardized data feed for motorbike race-related data. In addition, the second platform 706b is any parimutuel platform configured to accept and utilize the standardized data feed for providing real-time odds for betting on motorbike races. Further, the third platform 706c is another parimutuel platform in the described embodiment, intended to receive and process the standardized data feed for motorbike race-related information. There may be more platforms beyond the specifically mentioned ones. The platforms collectively form part of the system designed to process and present real-time odds for betting based on the analysed motorbike race data.

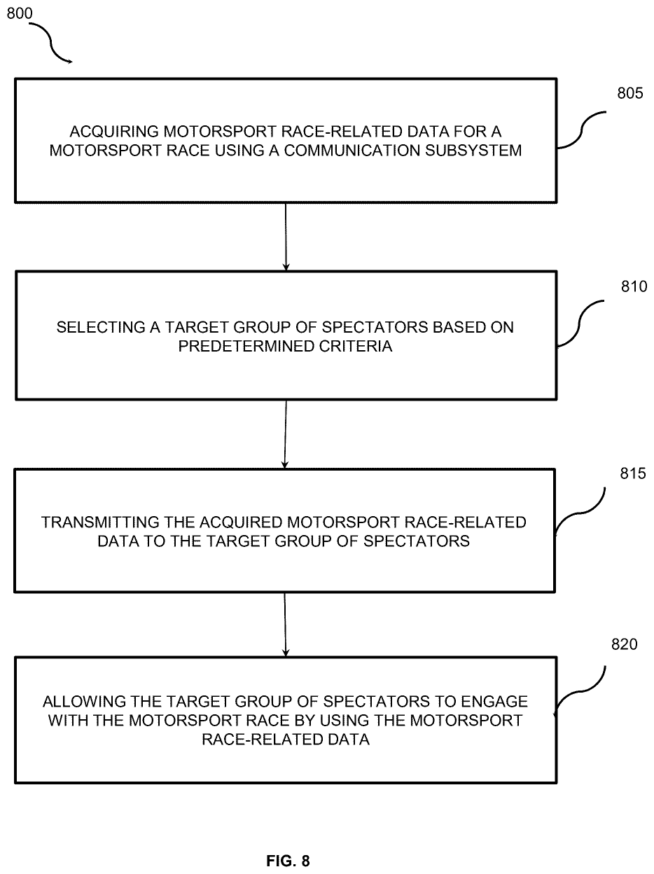

FIG. 8 is a block diagram illustrating a method 800 for enhancing the spectator experience during a motorbike race, in accordance with an embodiment of the present invention. In one specific embodiment, the flow chart 800 may include steps to illustrate the method for enhancing the spectator experience during the motorbike race. Other embodiments may include other steps to illustrate similar method.

In an embodiment of the present invention, the method initiates step 805 and terminates at step 820. At step 805, the method 800 may include acquiring a motorbike race related data (MRRD) for the motorbike race using a communication subsystem 502 (References have been made to FIG. 5).

In addition, the step 805 may also include acquiring transmission signals of live motorsport races, chosen from the group consisting of broadcast and streaming signals. Further, the step 805 includes using the communication subsystem 502 with at least one sensor for real-time data acquisition of motorsport races.

At step 810, a target group of spectators may be selected based on a predetermined criterion. In an embodiment of the present invention, the predetermined criteria for selecting the target group of spectators includes at least one of geographical location, user preferences, and user demographics. In another embodiment of the present invention, the predetermined criteria may or may not include other parameters performing similar function.

At step 815, the acquired MRRD may be transmitted to the target group of spectators. At step 820, the target group of spectators are allowed to engage with the motorbike race by using the MRRD to place parimutuel wagers about motorsport race outcomes, causing the spectators to have an enhanced spectator experience.

In an embodiment of the present invention, the enhanced spectator experience caused by the allowing step 820 may be chosen from the group consisting of participants in the motorbike race. The participants have an emotional experience during the motorbike race, enjoying the event more than they would have without the system 400, betting on the outcome of the motorbike race, or a combination of each of those things.

In an embodiment of the present invention, the step 820 of allowing the target group of spectators to engage with the motorbike race includes placing wagers on various motorbike race outcomes chosen from the group consisting of final times, final scores, driver statistics, player statistics, specific race events, and specific game events. In another embodiment of the present invention, the group of various motorbike race outcomes may include any other parameters relates to a specific game.

In an embodiment of the present invention, the method 800 further includes amalgamating and reformatting the MRRD into a standardized data feed that is receivable by parimutuel platforms that provide real-time odds for betting based upon the analyzed data.

In an exemplary embodiment of the present invention, a computer-readable medium includes computer-executable instructions for implementing the method for enhancing spectator experience during an event. In an example, the computer readable medium is but not limited to a memory card which can store software and instructions, CD-ROM that can be read by a computer's optical drive, DVD, USB Flash Drive, Hard Disk Drive to store both data and execute instructions, Solid State Drive, Magnetic Tape, Cloud Storage in which files and instructions are stored like Google Drive or drop box, network storage, remote repositories, ROM, EPROM and EEPROM.

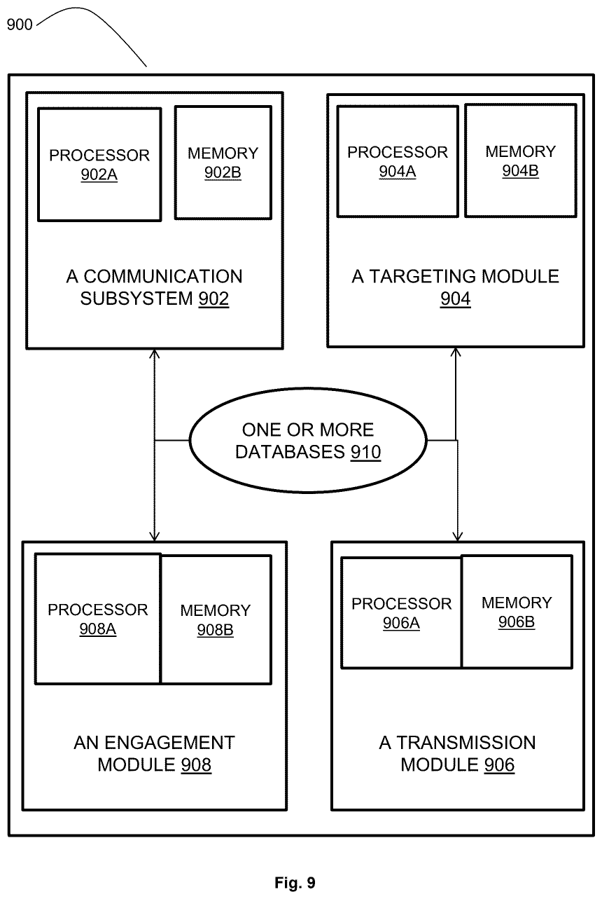

FIG. 9 is a flow chart 900 illustrating a system for enhancing spectator experience during an auction, in accordance with an embodiment of the present invention. The system 900 is configured for use in relation to the auction conducted by an auction house. In addition, the auction may include at least one offer to bidders of an item for sale and at least one unknown outcome for the at least one offer.

Further, the auction produces a known outcome (there may or may not be a winning bid). The system 900 may be configured for identifying the at least one unknown outcome to a target group prior to the bidding and for reporting to the target group of spectators the known outcome at conclusion of the bidding. Furthermore, the system 900 may be further configured for assessing a level of spectator engagement with the auction prior to the conclusion of the bidding

In a specific embodiment, the system 900 may include a communication subsystem 902, a targeting module 904, a transmission module 906 and an engagement module 908. Other embodiments of the present invention may or may not include other modules to describe the invention.

In an embodiment of the present invention, the communication subsystem 902 is configured to acquire auction-related data (ARD) associated with the auction and an estimated successful bid amount. The ARD may include the at least one offer of the item for sale and the at least one unknown outcome for the item for sale. In addition, the ARD comes from various auctions related to the auction.

In an embodiment of the present invention, the auction may be chosen from the group consisting of automobiles, motorcycles, watercraft, aircraft, furniture, real estate, art, antiquities, jewelleries, firearms, animals (horses, bulls), and collectibles such as coins, stamps, comic books, antique furniture, artwork, watches and posters. In an embodiment of the present invention, the ARD may be acquired by the communication subsystem 902 includes information related to auction items, such as descriptions, values, and current bid status.

In an embodiment of the present invention, the communication subsystem 902 may include a control subsystem 902a. The control subsystem 902a includes a processor 902b, at least one database 910 and a computer readable memory 902c may be including a processor-readable instruction that is executed by the processor 902b and cause the processor 902b to acquire the auction-related data (ARD) for the auction. The computer readable memory 902c in the control subsystem 902a is used to store the ARD.

The processor 902b associated with the control subsystem 902a may be any well-known processor, but not limited to processors from Intel Corporation. Alternatively, the processor 902b may be a dedicated controller such as an ASIC or ARM, MIPS, SPARC, or INTEL® IA-32 microcontroller.

Similarly, in yet another embodiment of the present invention, the processor 902b may comprise a collection of processors which may or may not operate in parallel. The processor 902b may be any processor-driven device, such as may include one or more microprocessors and memories or other computer-readable media operable for storing and executing computer-executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 902b may execute any set of instructions directly as computer executable codes or indirectly (such as scripts). In that regard, the terms “instructions,” and “steps” may be used interchangeably herein. The instructions may be stored in object code form for direct processing by the processor 902b, or in any other computer language including scripts or collections of independent source code modules that are interpreted on demand or compiled in advance.

In accordance with an embodiment of the present invention, the computer readable memory 902c may be configured with the processor for storing the ERD. For example, the computer readable memory 902c may store software used by a user interface or the processor, such as an operating system (not shown), application programs (not shown), and an associated internal database (not shown).

In addition, the computer readable memory 902c associated with the control subsystem 902a stores instructions to be executed by the control subsystem 902a. The computer readable memory 920c can be any type of suitable memory, including various types of dynamic random-access memory (DRAM) such as SDRAM, various types of static RAM (SRAM), and various types of non-volatile memory (PROM, EPROM, and flash). It should be understood that the computer readable memory 902c may be a single type of memory component or it may be composed of many different types of memory components. As noted above, the computer readable memory 902c stores instructions for executing one or more methods for enhancing spectator experience during an auction. For example, the computer readable memory may store software used by the user device, such as an operating system (not shown), application programs (not shown), and an associated internal database (not shown). In an alternative embodiment, the computer readable memory 902c may be an external memory to the control subsystem 902a to store various data and computer executable instructions.

In some embodiments, the computer readable memory 902c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 902c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, electrostatic and storage devices such as solid-state drives.

In an embodiment of the present invention, the communication subsystem 902 may include one or more sensors (not shown in figures) for real-time data acquisition of the auction. In an example, the one or more sensors may be placed around the auction venue to monitor environmental conditions such as temperature, humidity, and wind speed. In accordance with an embodiment of the present invention, the data from the one or more sensors is transmitted to the target group of spectators.

In an embodiment of the present invention, the communication subsystem 902 may be configured to acquire transmission signals of live auction, chosen from the group consisting of broadcast and streaming signals. In an example, the communication subsystem 902 may be wired or wireless. The wired communication may include any of but not limited to landline phones which uses copper wires transmit voice signals and fibre-optic communication which transmits data using light signals through optical fibres. The wireless communication includes but not limited to Wi-Fi which allows devices to connect through the internet and communicate wirelessly and Bluetooth which is used for short-range connections between devices like headphones and smart phones. In addition, the communication subsystem 902 is but not limited to a plurality of smart phones which use cellular networks to transmit voice, text messages, and data and a plurality of cell towers which use relay signals from the phones to the network.

In another example, the communication subsystem 902 may be a telemetry system which allows for real-time analysis and decision-making during the auction. In yet another example, the communication system 902 may include cameras mounted on race cars in case the auction is based on a race event, to capture video footage, which is streamed to the race control centre and broadcasted to the fans. In yet another example, the communication system 902 may integrate with timing and scoring equipment to provide precise information about lap times, sector times and race positions to teams, race control and spectators in case of a race event. In yet another example, the communication system 902 may include any team communication networks and data distribution to spectators. The above-mentioned examples illustrate that a communication system can be configured to acquire, process, and distribute ARD to various spectators, enhancing the auction experience and ensuring the safety and efficiency of auction events.

In addition, the communication subsystem 902 may include one or more sensors (not shown in figures) for real-time data acquisition of the auction. In an embodiment of the present invention, the communication subsystem 902 is configured to acquire transmission signals of live auction, chosen from the group consisting of broadcast and streaming signals.

In an embodiment of the present invention, the targeting module 904 may be configured to select a target group of spectators based on a predetermined criterion. In an embodiment of the present invention, the predetermined criteria for selecting the target group of spectators includes at least one of user preferences, user demographics, and previous betting behaviour. In another embodiment of the present invention, the predetermined criterion may or may not include other parameters performing similar function.

In an embodiment of the present invention, the targeting module 904 includes a control subsystem 904a. The control subsystem 904a includes a processor 904b, the least one database 910 and a computer readable memory 904c including a processor-readable instruction that is executed by the processor 904b and cause the processor 904b to select the target group of spectators based on the predetermined criterion. The computer readable memory 904c in the control subsystem 904a is used to store the target group of spectators.

In an embodiment of the present invention, the processor 904b, the computer readable memory 904c and the one or more database 910 of the targeting module 904 may be any of the above-mentioned processor, memory and database used for the communication subsystem 902.

In an embodiment of the present invention, the predetermined criteria for selecting the target group of spectators includes at least one of geographical location, user preferences, and user demographics. In another embodiment of the present invention, the predetermined criterion may or may not include other parameters performing similar function.

In an example, the targeting module 904 may select the target group of spectators by using a ticket type targeting in which different ticket categories can be used as a criterion to tailor messages, offers, and experiences to specific ticket holders. In another example, the targeting module 904 may select the target group of spectators using location-based targeting in which spectators situated in different areas of the auction can receive targeted information.

In yet another example, the targeting module 904 may select the target group of spectators by determining their interests, such as favorite racing teams or drivers, and deliver updates, statistics, and special content related to those preferences. In yet another example, the targeting module 904 may select the target group of spectators based on engagement level in which spectators who actively engage with the auction app or show a high level of interest by checking into different auction locations can receive rewards or recognition for their participation.

In an embodiment of the present invention, the targeting module 904 may select the target group of spectators based on user demography in which criteria such as age, gender or language preference can be used to customize content and promotions. For instance, families with children might receive information about kid-friendly activities at the auction.

In an embodiment of the present invention, the transmission module 906 is configured to transmit the acquired ARD to the target group of spectators. In an embodiment of the present invention, the transmission module 906 includes a control subsystem 906a. The control subsystem includes a processor 906b, the least one database 910 and a computer readable memory 906c including a processor-readable instruction that is executed by the processor 906b and causes the processor 506c to transmit the acquired ERD to the target group of spectators.

In an embodiment of the present invention, the processor 906b, the computer readable memory 906c and the one or more database 910 of the transmission module 906 may be any of the above-mentioned processor, memory and database used for the transmission module 906.

In an example, the transmission module 906 may transmit the acquired ERD to the target group of spectators by delivering real-time commentary, auction updates, and announcements to spectators in the stands, providing insights into the auction, driver statistics, and auction-related news.

In another example, the transmission module 906 may transmit the acquired ERD to the target group of spectators by using live audio where spectators can access live radio broadcasts or audio commentary on their smart phones or portable radios, allowing them to choose their preferred audio feed, including team radio communications.

In yet another example, the transmission module 506 may transmit the acquired ERD to the target group of spectators by providing live auction coverage and in-car camera feeds on their smart phones or tablets. Different camera angles and driver-specific feeds can be offered for a more personalized experience.

In yet another example, the transmission module 906 may transmit the acquired ERD by using real-time leader boards and statistics, fan engagements apps, social media feeds, and fan zone information.

In an embodiment of the present invention, the engagement module 908 may allow the target group of spectators to interact with the auction by using the ARD to place bets associated with auction-bid outcomes. In an embodiment of the present invention, the enhanced spectator experience caused by the engagement module is chosen from the group consisting of participants in the auction, having an emotional experience during the auction, enjoying the auction more than they would have without the system 900, betting on the outcome of the auction, or a combination of each of those things.

Further, the engagement module 908 may allow the target group of spectators to place bets on the successful-bid amount in real-time, with the option to increase their bets during the auction. In an embodiment of the present invention, the system 900 may further include a data processing module (not shown in figures) configured to analyse the ARD and provide real-time successful-bid odds based on the analysed data, including current auction item values and bid histories.

In an embodiment of the present invention, the engagement module 908 may include a control subsystem 908a. The control subsystem 908a includes a processor 908b, the least one database 910 and a computer readable memory 908c including a processor-readable instruction that is executed by the processor 908b and cause the processor 908c to interact with the motorsport race by using the ERD, causing the spectators to have an enhanced spectator experience.

In an embodiment of the present invention, the processor 908b, the computer readable memory 908c and the one or more database 910 of the engagement module 908 may be any of the above-mentioned processor, memory and database used for the communication subsystem 902.

In an example, a dedicated mobile app may allow spectators to place wagers on various auction outcomes, such as the winner, podium winner, podium finishers, fastest lap, or the number of safety car period.

In another example, the engagement module 908 may allow interaction of the target group of spectators by providing a live betting platform where spectators can use a real-time betting platform to make dynamic wagers during the auction, adjusting their bets as the auction unfold.

In yet another example, the engagement module 908 may allow interaction of the target group of spectators providing auction in which wagers can be placed on individual driver performance in case of a race event, such as predicting the number of overtakes, the driver with the most laps led, or who will finish as the top-ranked driver for a particular team.

In yet another example, the engagement module 908 may allow participation of the target group of spectators by using championship betting, safety car betting, driver head-to-head betting, live betting challenges, in race betting contests, and social betting pools, in case of an auction on a competitive event such as racing.

In an embodiment of the present invention, the system 900 may establish a two-way communication between the motorsport race and the spectator. The two-way communication may allow the spectator to have enhanced engagement with the auction.

In an embodiment of the present invention, the engagement module 908 may enable the target group of spectators to place parimutuel wagers on the finish order. In addition, the engagement module 908 may be configured to allow the target group of spectators to use the ARD to place bets, including over and under ones, about aspects of an auction chosen from the group consisting of the driver who had the lead for the most laps in case of a racing event, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.

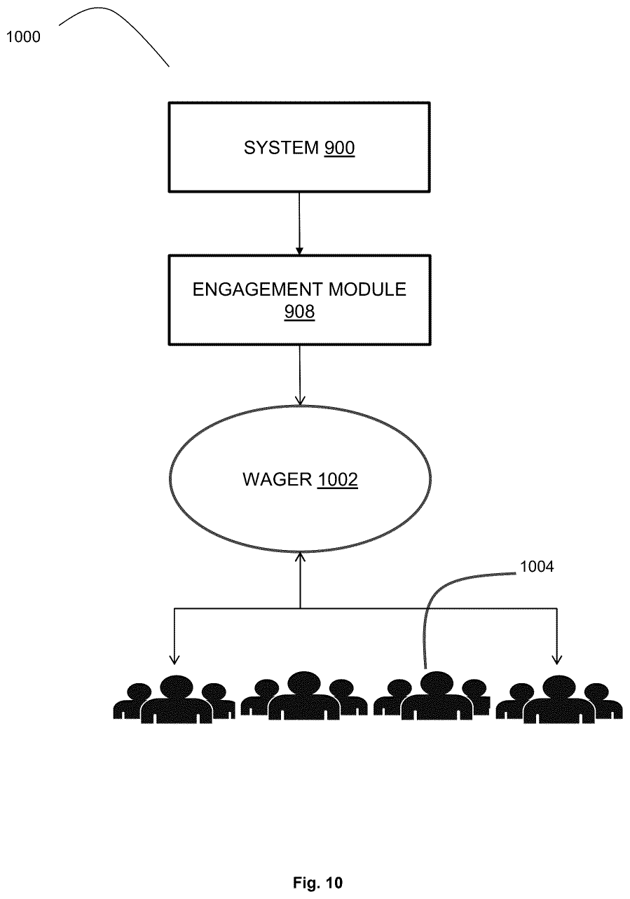

FIG. 10 is a diagrammatic representation 1000 of the engagement module 908 associated with the system 900, in accordance with an exemplary embodiment of the present invention (References have been made to FIG. 9). The engagement module 908 measures the level of spectator engagement by offering wagers to a target group of spectators 1004 and collecting wagers 1002 from the target group of spectators 1004.

In an embodiment of the present invention, the engagement module 908 may provide to the target group of spectators 1004, prior to the bidding, an estimated successful bid amount. Further, the engagement module 908 may provide at least one update to the estimated successful bid amount to the target group of spectators 1004 during the bidding. The engagement module 908 may offer wagers 1002 to the target group of spectators based on the estimated successful bid amount.

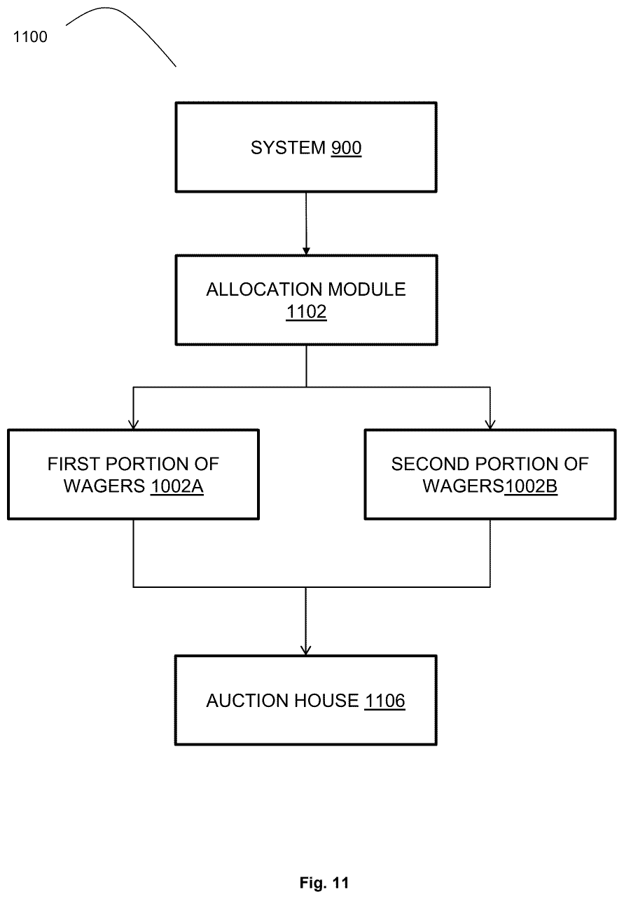

FIG. 11 is a diagrammatic representation 1100 of an allocation module 1102 associated with the system 900, in accordance with an exemplary embodiment of the present invention. The allocation module 1102 may be configured to designate and transmit a portion of the wagers 1002 to the auction house 1106 (References have been made to FIG. 10).

In an example, the allocation module 1102 may allocate a first portion of the wagers 1002a and a second portion of the wagers 1002b to the auction house 1106. In another example, the allocation module 1102 “n” portion of the wagers to the auction house 1106, where “n”is a natural number.

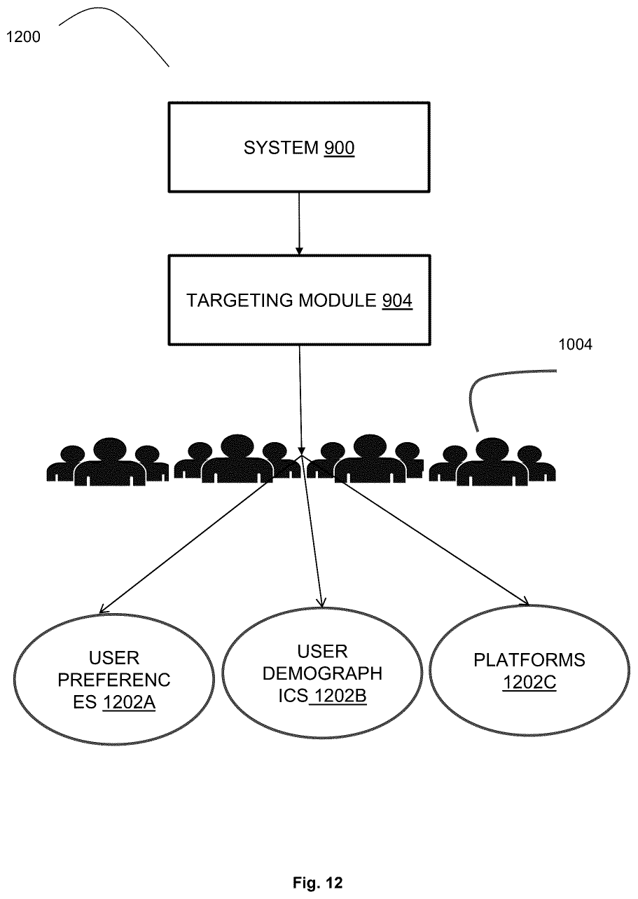

FIG. 12 is a diagrammatic representation 1200 illustrating the targeting module 904 associated with the system 900, in accordance with an exemplary embodiment of the present invention. The targeting module 904 may be configured to select the target group of spectators 1004. In an embodiment of the present invention, the target group of spectators are selected based on a predetermined criterion. The predetermined criterion may include a plurality of user preferences 1202a, a plurality of user demographics 1202b and a plurality of platforms 1202c.

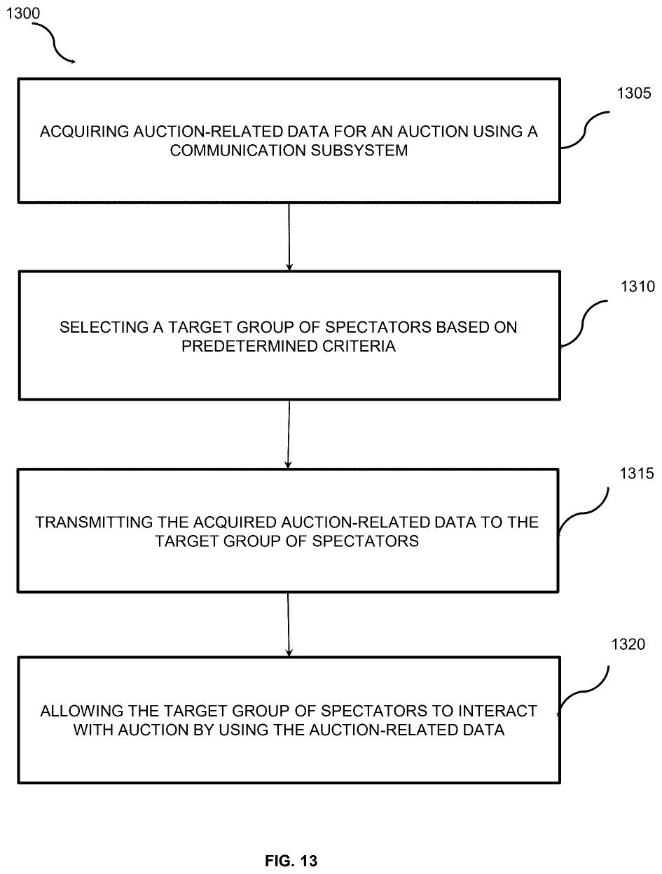

FIG. 13 is a flow chart 1300 illustrating a method for enhancing the spectator experience during an auction, in accordance with an embodiment of the present invention. In an embodiment of the present invention, the auction is chosen from the group consisting of automobiles, motorcycles, watercraft, aircraft, furniture, and collectibles. In one specific embodiment, the flow chart 1300 may include steps to illustrate the aforementioned method for enhancing the spectator experience during the auction. Other embodiments may include other steps to illustrate similar method.

In an embodiment of the present invention, the method may initiate step 1305 and terminates at step 1320. At step 1305, an auction-related data (ARD) associated with the auction and an estimated successful bid amount is acquired using a communication subsystem 902 (References have been made to FIG. 9). In an embodiment of the present invention, the acquired ARD includes information related to auction items, such as descriptions, values, current bid status, previous and other auction results.

At step 1310, a target group of spectators may be selected based on predetermined criteria. In an embodiment of the present invention, the step of selecting 1310 the target group of spectators is based on predetermined criteria, including user preferences, user demographics, and previous betting behaviour.

At step 1315, the acquired ARD may be transmitted to a target group of spectators. At step 1320, the target group of spectators may be allowed to interact with the auction by using the ARD to place bets associated with auction-bid outcomes. In an embodiment of the present invention, the step 1320 of allowing the target group of spectators to place bets on the successful-bid amount in real-time, with the option to increase their bets during the auction.

In an embodiment of the present invention, the method may further include a step of analysing the ARD and provides real-time successful-bid odds based on the analysed data, including current auction item values, and bid histories.

In an embodiment of the present invention, a computer-readable medium includes computer-executable instructions for implementing the method for enhancing spectator experience during an auction. In an example, the computer readable medium is but not limited to a memory card which can store software and instructions, CD-ROM that can be read by a computer's optical drive, DVD, USB Flash Drive, Hard Disk Drive to store both data and execute instructions, Solid State Drive, Magnetic Tape, Cloud Storage in which files and instructions are stored like Google Drive or dropbox, network storage, remote repositories, ROM, EPROM and EEPROM.

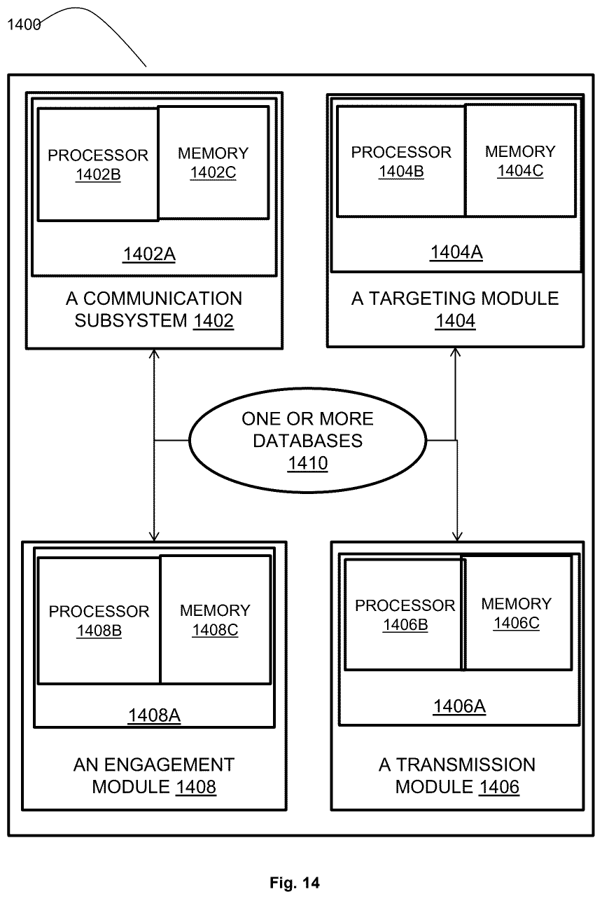

FIG. 14 is a block diagram illustrating a system 1400 for enhancing spectator experience during an animal event produced by an event producer, in accordance with an embodiment of the present invention. The animal event may be occurring between a beginning time and a completion time and producing one or more categories of interim outcomes between the beginning time up to the completion time.

The interim outcomes are unknown prior to the beginning time, the system may be configured for identifying the one or more categories of interim outcomes to a target group of spectators. The system 1400 further configured for reporting to the target group of spectators in a period between the beginning time and the completion time the interim outcomes as they become known during the event, and for measuring a level of spectator engagement with the animal event.

In an embodiment of the present invention, the animal event may be chosen from the group consisting of rodeos, stock shows, bullfights, and circuses. In a specific embodiment, the system 1400 includes a communication subsystem 1402, a targeting module 1404, a transmission module 1406 and an engagement module 1408. Other embodiments of the present invention may or may not include other modules to describe the invention.

In an embodiment of the present invention, the communication subsystem 1402 may be configured to acquire animal-event-related data (AERD) for the animal event. The communication subsystem 1402 may further includes one or more sensors (not shown in figures) for real-time data acquisition of the animal event.

In an embodiment of the present invention, the communication subsystem 1402 may include a control subsystem 1402a. The control subsystem includes a processor 1402b, at least one database 1410 and a computer readable memory 1402c including a processor-readable instruction that is executed by the processor 1402b and may cause the processor 1402b to acquire the animal event-related data (AERD) for the animal event. In an embodiment of the present invention, the AERD may include the one or more categories of interim outcomes before the beginning time of the event and the interim outcomes as they become known during the event.

The computer readable memory 1402c in the control subsystem 1402a is used to store the AERD. The processor 1402b associated with the control subsystem 1402a may be any well-known processor, but not limited to processors from Intel Corporation. Alternatively, the processor may be a dedicated controller such as an ASIC or ARM, MIPS, SPARC, or INTEL® IA-32 microcontroller.

Similarly, in yet another embodiment of the present invention, the processor 1402b may comprise a collection of processors which may or may not operate in parallel. The processor 1402b may be any processor-driven device, such as may include one or more microprocessors and memories or other computer-readable media operable for storing and executing computer-executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 1402b may execute any set of instructions directly as computer executable codes or indirectly (such as scripts). In that regard, the terms “instructions,” and “steps” may be used interchangeably herein. The instructions may be stored in object code form for direct processing by the processor 1402b, or in any other computer language including scripts or collections of independent source code modules that are interpreted on demand or compiled in advance.

In accordance with an embodiment of the present invention, the computer readable memory 1402c may be configured with the processor for storing the ERD. For example, the computer readable memory 1402c may store software used by a user interface or the processor, such as an operating system (not shown), application programs (not shown), and an associated internal database (not shown).

In addition, the computer readable memory 1402c associated with the control subsystem 1402a stores instructions to be executed by the control subsystem 1402a. The computer readable memory 1402c can be any type of suitable memory, including various types of dynamic random-access memory (DRAM) such as SDRAM, various types of static RAM (SRAM), and various types of non-volatile memory (PROM, EPROM, and flash). It should be understood that the computer readable memory 102c may be a single type of memory component or it may be composed of many different types of memory components. As noted above, the computer readable memory 1402c stores instructions for executing one or more methods for enhancing spectator experience during the animal event. For example, the computer readable memory 1402c may store software used by the user device, such as an operating system (not shown), application programs (not shown), and an associated internal database (not shown). In an alternative embodiment, the computer readable memory 1402c may be an external memory to the control subsystem 1402a to store various data and computer executable instructions.

In some embodiments, the computer readable memory 1402c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non-transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 702c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, and electrostatic storage devices such as solid-state drives.

In an embodiment of the present invention, the communication subsystem 1402 may include one or more sensors (not shown in figures) for real-time data acquisition of the animal event. In an example, the one or more sensors may be placed around the event track to monitor environmental conditions such as temperature, humidity and wind speed, track condition such as grip levels and debris, safety status. In accordance with an embodiment of the present invention, the data from the one or more sensors is transmitted to the target group of spectators.

In an embodiment of the present invention, the communication subsystem 1402 may be configured to acquire transmission signals of live animal events, chosen from the group consisting of broadcast and streaming signals. In an example, the communication subsystem 1402 may be wired or wireless. The wired communication includes but not limited to landline phones which uses copper wires transmit voice signals and fibre-optic communication which transmits data using light signals through optical fibres. The wireless communication includes but not limited to Wi-Fi which allows devices to connect through the internet and communicate wirelessly and Bluetooth which is used for short-range connections between devices like headphones and smart phones. In addition, the communication subsystem 1402 is but not limited to a plurality of smart phones which use cellular networks to transmit voice, text messages, and data and a plurality of cell towers which use relay signals from the phones to the network.

In another example, the communication subsystem 1402 may be a telemetry system which allows for real-time analysis and decision-making during the animal event in which animals are equipped with the telemetry system that continuously transmit MRRD, including engine performance, speed, tire condition, fuel levels, and driver biometrics, back to the team's pit area which allows for real-time analysis and decision-making during the animal event.

In yet another example, the communication system 1402 may include cameras mounted on animals to capture video footage, which is streamed to the animal event control centre and broadcasted to the fans. In yet another example, the communication system 1402 may integrate with timing and scoring equipment to provide precise information about lap times, sector times and race positions to teams, race control and spectators.

In yet another example, the communication system 1402 may include any of trackside sensors, GPS tracking, race data analysis tools, driver biometrics, team communication networks and data distribution to spectators. The above-mentioned examples illustrate that a communication system can be configured to acquire, process, and distribute animal event-related data (AERD) to various spectators, enhancing the racing experience and ensuring the safety and efficiency of animal events.

In an embodiment of the present invention, the targeting module 1404 is configured to select a target group of spectators based on a predetermined criterion. In addition, the target group of spectators is selected before the beginning time of the animal event and during the animal event. In an embodiment of the present invention, the predetermined criteria for selecting the target group of spectators includes at least one of geographical location, user preferences, and user demographics.

In an embodiment of the present invention, the targeting module 1404 includes a control subsystem 1404a. The control subsystem 1404a includes a processor 1404b, the least one database 1410 and a computer readable memory 1404c including a processor-readable instruction that is executed by the processor 1404b and cause the processor 1404b to select the target group of spectators based on the predetermined criterion. The computer readable memory 1404c in the control subsystem 1404a is used to store the target group of spectators.

In an embodiment of the present invention, the processor, the computer readable memory 1404c and the one or more database 1410 of the targeting module 1404 may be any of the above-mentioned processor, memory and database used for the communication subsystem 1402.

In an embodiment of the present invention, the predetermined criteria for selecting the target group of spectators includes at least one of geographical location, user preferences, and user demographics. In another embodiment of the present invention, the predetermined criterion may or may not include other parameters performing similar function.

In an example, the targeting module 1404 may select the target group of spectators by using a ticket type targeting in which different ticket categories can be used as a criterion to tailor messages, offers, and experiences to specific ticket holders. In another example, the targeting module 1404 may select the target group of spectators using location-based targeting in which spectators situated in different areas of the racetrack can receive targeted information.

In yet another example, the targeting module 1404 may select the target group of spectators by determining their interests, such as favorite animal event teams or drivers, and deliver updates, statistics, and special content related to those preferences. In yet another example, the targeting module 1404 may select the target group of spectators based on engagement level in which spectators who actively engage with the animal event even app or show a high level of interest by checking into different race locations can receive rewards or recognition for their participation.

In an embodiment of the present invention, the targeting module 1404 may select the target group of spectators based on user demography in which criteria such as age, gender or language preference can be used to customize content and promotions. For instance, families with children might receive information about kid-friendly activities at the animal event.

In an embodiment of the present invention, the transmission module 1406 may be configured to transmit the acquired AERD to the target group of spectators. In an embodiment of the present invention, the transmission module 1406 includes a control subsystem 1406a. The control subsystem includes a processor 1406b, the least one database 1410 and a computer readable memory 1406c including a processor-readable instruction that is executed by the processor 1406b and causes the processor 1406b to transmit the acquired AERD to the target group of spectators.

In an embodiment of the present invention, the processor 1406b, the computer readable memory 1406c and the one or more database 1410 of the transmission module 1406 may be any of the above-mentioned processor, memory and database used for the transmission module 1406.

In an example, the transmission module 1406 transmits the acquired AERD to the target group of spectators by delivering real-time commentary, race updates, and announcements to spectators in the stands, providing insights into the race, driver statistics, and event-related news.

In another example, the transmission module 1406 transmits the acquired AERD to the target group of spectators by using live audio where spectators can access live radio broadcasts or audio commentary on their smart phones or portable radios, allowing them to choose their preferred audio feed, including team radio communications.

In yet another example, the transmission module 1406 transmits the acquired AERD to the target group of spectators by providing live animal event coverage and in-car camera feeds on their smart phones or tablets. Different camera angles and driver-specific feeds can be offered for a more personalized experience.

In yet another example, the transmission module 1406 transmits the acquired AERD by using real-time leader boards and statistics, fan engagements apps, social media feeds, and fan zone information.

In an embodiment of the present invention, the engagement module 1408 allows the target group of spectators to interact with the animal event by using the AERD to place bets about animal-event outcomes. In an embodiment of the present invention, the engagement module 1408 enables the target group of spectators to place bets on various animal-event outcomes chosen from the group consisting of final times, animal-trainer statistics, animal statistics, and specific event outcomes. In addition, the engagement module 1408 measures the level of spectator engagement.

In an embodiment of the present invention, the system 1400 further includes a data-processing module configured to analyse the AERD and provide real-time odds for betting on animal-event outcomes based on the analysed data.

In an embodiment of the present invention, the engagement module 1408 may include a control subsystem 1408a. The control subsystem 1408a may include a processor 1408b, the least one database 1410 and a computer readable memory 1408c including a processor-readable instruction that is executed by the processor 1408b and may cause the processor 1408b to interact with the animal event by using the AERD, causing the spectators to have an enhanced spectator experience.

In an example, a dedicated mobile app may allow spectators to place wagers on various animal event outcomes, such as the winner, podium winner, podium finishers, fastest lap, or the number of safety car period.

In another example, the engagement module 1408 may allow interaction of the target group of spectators by providing a live betting platform where spectators can use a real-time betting platform to make dynamic wagers during the animal event, adjusting their bets as the animal event unfolds.

In yet another example, the engagement module 1408 may allow interaction of the target group of spectators providing driver performance betting such in which wagers can be placed on individual driver performance, such as predicting the number of overtakes, the driver with the most laps led, or who will finish as the top-ranked driver for a particular team. In yet another example, the engagement module 1408 allows participation of the target group of spectators by using championship betting, safety car betting, driver head-to-head betting, live betting challenges, in race betting contests, and social betting pools.

In an embodiment of the present invention, the system 1400 may establish a two-way communication between the animal event and the spectator. The two-way communication allows the spectator to have enhanced engagement with the animal event.

In an embodiment of the present invention, the engagement module 1408 may enable the target group of spectators to place parimutuel wagers on the finish order. In addition, the engagement module 1408 is configured to allow the target group of spectators to use the AERD to place bets, including over and under ones, about aspects of an animal event chosen from the group consisting of the lead for the most laps, the number of laps under a caution flag, the number of caution flags, the first driver to make a pit stop, the winning animal number, whether the winning animal number is an odd or even number, and the winning animal.

In an embodiment of the present invention, the system 1400 may further include a data processing module (not shown in figures) configured to amalgamate and reformat the AERD into a standardized data feed that is receivable by parimutuel platforms that provide real-time odds for betting based upon the analyzed data.

In an embodiment of the present invention, the processor 1408b, the computer readable memory 1408c and the one or more database 1410 of the engagement module 1408 may be any of the above-mentioned processor, memory and database used for the communication subsystem 1402.

In an embodiment of the present invention, the system 1400 includes an allocation module configured to designate and transmit producer a portion of the wagers to the event. The allocation module splits the portion of wagers between an owner of the animal, a jockey of the animal and a trainer. In an exemplary embodiment of the present invention, the owner of the animal keeps 80% of the wagers and the jockey and each of the trainer received 10% of the total amount of wagers.

In an embodiment of the present invention, a two-way communication is established between the animal event and the spectator where the two-way communication allows the spectator to have an enhanced spectator experience during the animal event.

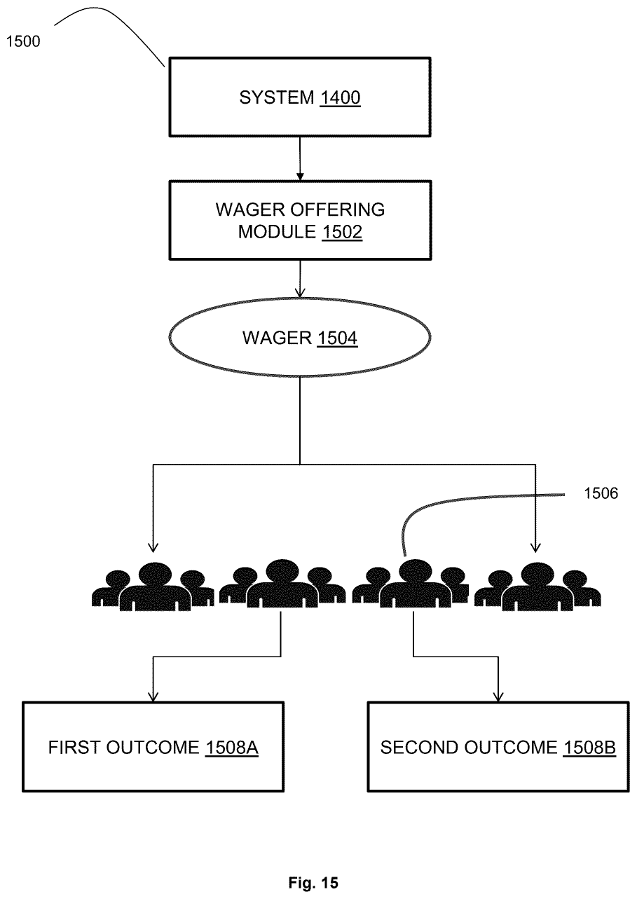

FIG. 15 is a diagrammatic representation of a wager offering module 1502 configured to offer wagers 1504 to a target group of spectators 1506 on interim outcomes between the beginning time and the completion time. In an embodiment of the present invention, the wager offering module 1502 may be associated with the system 1400 to enhance the experience of the target group of spectators 1506 which are engaged with the animal event.

In addition, the animal event may have “n” number of interim outcomes, where “n” is a natural number. In an exemplary embodiment of the present invention, the interim outcomes of the animal event may include a first outcome 1508a and a second outcome 1508b. In an example, the first outcome 1508a and the second outcome 1508b may include an animal winning a fight over the other animal during a time interval. In another embodiment of the present invention, the interim outcomes is chosen from the group consisting of final times and other data pertinent to animals, animal-trainers, animal-riders in a rodeo, and specific event outcomes other than final times.

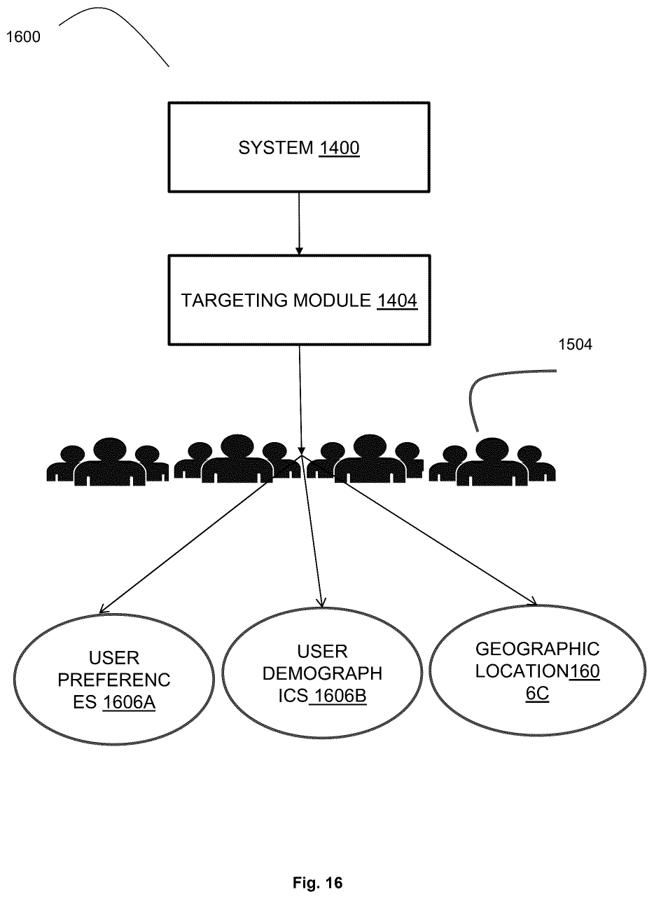

FIG. 16 is a diagrammatic representation 1600 of the targeting module 1404 associated with the system 1400, in accordance with an embodiment of the present invention. The targeting module 1404 is configured to select a target group of spectators 1504 based on a predetermined criterion.

In accordance with an embodiment of the present invention, the predetermined criteria for selecting the target group of spectators 1504 may include any of a plurality of user preferences 1506a, a plurality of user demographics 1506b and a plurality of geographic locations 106c. In another embodiment of the present invention, the predetermined criteria for selecting the target group of spectators 1504 may include other factors influencing a user experience.

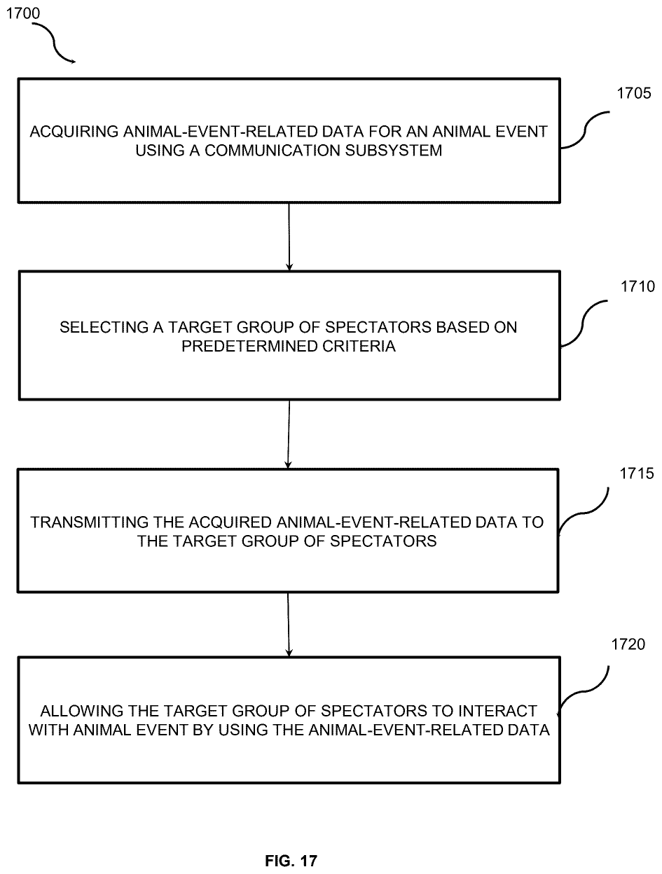

FIG. 17 is a block diagram illustrating a method 1700 for enhancing the spectator experience during an animal event, in accordance with an embodiment of the present invention. In an embodiment of the present invention, the animal event may be chosen from the group consisting of rodeos, stock shows, bullfights, and circuses. In one specific embodiment, the block diagram includes steps to illustrate the aforementioned method 1700 for enhancing the spectator experience during the animal event. Other embodiments may include other steps to illustrate similar method.

In an embodiment of the present invention, the method 1700 may initiate step 1705 and terminates at step 1720. At step 1705, animal-event-related data (AERD) for the animal event is acquired using a communication subsystem 1402 (References have been made to FIG. 14). In an embodiment of the present invention, all the AERD is amalgamated into a standardized date format to enable transmission through plural third parties involved in the animal event.

At step 1710, a target group of spectators may be selected based on predetermined criteria. In an embodiment of the present invention, the predetermined criteria for selecting the target group of spectators includes at least one of geographical location, user preferences, and user demographics.

At step 1715, the acquired AERD may be transmitted to the target group of spectators. At step 1720, the target group of spectators may be allowed to engage with the animal event by using the AERD to place bets about animal-event outcomes. In an embodiment of the present invention, the step 1720 of allowing the target group of spectators to engage with the animal event includes placing bets on various animal-event outcomes, including but not limited to final scores, player statistics, and specific game and domesticated animal events.

In an embodiment of the present invention, the method 1700 further includes real-time analysis of the AERD which provides updated odds for betting to the target group of spectators.

In an embodiment of the present invention, a computer-readable medium includes computer-executable instructions for implementing the method 1700 for enhancing spectator experience during an animal event. In an example, the computer readable medium is but not limited to a memory card which can store software and instructions, CD-ROM that can be read by a computer's optical drive, DVD, USB Flash Drive, Hard Disk Drive to store both data and execute instructions, Solid State Drive, Magnetic Tape, Cloud Storage in which files and instructions are stored like Google Drive or dropbox, network storage, remote repositories, ROM, EPROM and EEPROM.

The invention may also be described in the following numbered paragraphs:
1. A system for use in relation to an event produced by an event producer, the event occurring between a beginning time and an end time and producing one or more categories of interim outcomes between the beginning time up to the end time, wherein the interim outcomes are unknown prior to the beginning time, the system configured for identifying the one or more categories of interim outcomes to a target group of spectators, the system further configured for reporting to the target group of spectators in a period between the beginning time and the end time the interim outcomes as they become known during the event, and for measuring a level of spectator engagement with the event, the system comprising:
   i. a communication subsystem configured to acquire event-related data (ERD), the ERD including the one or more categories of interim outcomes before the beginning time of the event and the interim outcomes as they become known during the event;
   ii. a targeting module configured to select the target group of spectators based on a predetermined criterion;
   iii. a transmission module configured to transmit the acquired ERD to the target group of spectators before the beginning time of the event and during the event; and
   iv. an engagement module allowing the target group of spectators to interact with the event by using the ERD and the engagement module measuring the level of spectator engagement.
2. The system as claimed in paragraph 1, further comprising a wager offering module configured to offer wagers to the target group of spectators on interim outcomes between the beginning time and the end time.
3. The system as claimed in paragraph 1, wherein the engagement module allows for the target group of spectators to place wagers between the beginning time and the end time on one or more of the interim outcomes.
4. The system as claimed in paragraph 1, wherein the engagement module measures the level of spectator engagement based at least in part from the wagers placed by the target group of spectators.
5. The system as claimed in paragraph 1, wherein the engagement module measures the level of spectator engagement based on at least one factor chosen from the group consisting of participating in the event, having an emotional experience during the event, enjoying the event more than they would have without the system, betting on the outcome of the event, or a combination of each of those things.
6. The system as claimed in paragraph 1, further comprising a data processing module configured to analyze the ERD and provide real-time odds for betting on the event outcome based on the analyzed data.
7. The system as claimed in paragraph 1, wherein the communication subsystem further comprises one or more sensors for real-time data acquisition of the event.
8. The system as claimed in paragraph 1, wherein the predetermined criteria for selecting the target group of spectators includes at least one of geographical location, user preferences, and user demographics.
9. The system as claimed in paragraph 1, wherein the engagement module enables the target group of spectators to place bets on various event outcomes chosen from the group consisting of final times, final scores, driver statistics, player statistics, specific race events, and specific game events.
10. The system as claimed in paragraph 1, wherein a two-way communication is established between the event and the spectator, wherein the two-way communication allows the spectator to have enhanced engagement with the event.
11. The system as claimed in paragraph 1, wherein the event is, but not limited to, a motorsports race, an animal event, a car race, and an auction.
12. A method for enhancing the spectator experience during an event, comprising the steps of:
   i. acquiring event-related data (ERD) for an event using a communication subsystem;
   ii. selecting a target group of spectators based on predetermined criteria;
   iii. transmitting the acquired ERD to the target group of spectators; and
   iv. allowing the target group of spectators to engage with the event by using the ERD, causing the spectators to have an enhanced spectator experience.
13. The method as claimed in paragraph 12, wherein the enhanced spectator experience caused by the allowing step is chosen from the group consisting of participating in the event, having an emotional experience during the event, enjoying the event more than they would have without the system, betting on the outcome of the event, or a combination of each of those things.
14. The method as claimed in paragraph 12, further comprising real-time analysis of the ERD to provide updated odds for betting to the target group of spectators.
15. The method as claimed in paragraph 12, wherein the predetermined criteria for selecting the target group of spectators includes at least one of geographical location, user preferences, and user demographics.
16. The method as claimed in paragraph 12, wherein the step of allowing the target group of spectators to engage with the event includes placing bets on various event outcomes chosen from the group consisting of final times, final scores, driver statistics, player statistics, specific race events, and specific game events.
17. The method as claimed in paragraph 12, wherein all the ERD is amalgamated into a standardized date format to enable transmission through a plurality of third parties involved in the event.
18. A computer-readable medium comprising computer-executable instructions for implementing the method of enhancing the spectator experience during an event, as recited in paragraph 12.
19. A system for use in relation to a motorsport race produced by an event producer, the system configured for collecting wagers from a betting populace and for allocating a portion of the wagers as revenue to the event producer and for enhancing spectator experience during a motorsport race, comprising:
   i. a communication subsystem configured to acquire motorsport race-related data (MRRD) for the motorsport race;
   ii. a targeting module configured to select a target group of spectators based on a predetermined criteria;
   iii. a transmission module configured to transmit the acquired MRRD to the target group of spectators;
   iv. an engagement module configured to allow the target group of spectators to interact with the motorsport race by using the MRRD to place parimutuel wagers about motorsport race outcomes; and
   v. an allocation module configured to designate and transmit to the event producer a portion of the parimutuel wagers.
20. The system as claimed in paragraph 19, further comprising a data processing module configured to amalgamate and reformat the MRRD into a standardized data feed that is receivable by parimutuel platforms that provide real-time odds for betting based upon the analyzed data.
21. The system as claimed in paragraph 19, wherein the communication subsystem is also configured to acquire transmission signals of live motorsport races, chosen from the group consisting of broadcast and streaming signals.
22. The system as claimed in paragraph 19, wherein the engagement module is also configured to allow the target group of spectators to use the MRRD to place bets, including over and under ones, about aspects of a motorsport race chosen from the group consisting of the driver who had the lead for the most laps, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.
23. The system as claimed in paragraph 19, wherein the communication subsystem further comprises one or more sensors for real-time data acquisition of the motorsport race.
24. The system as claimed in paragraph 19, wherein the predetermined criteria for selecting the target group of spectators includes at least one of geographical location, user preferences, and user demographics.
25. The system as claimed in paragraph 19, wherein the engagement module enables the target group of spectators to place parimutuel wagers on the finish order.
26. The system as claimed in paragraph 19, wherein a two-way communication is established between the motorsport race and the spectator, wherein the two-way communication allows the spectator to have enhanced engagement with the motorsport race.
27. A method for enhancing the spectator experience during an motorsport race, comprising the steps of:
   i. acquiring motorsport race-related data (MRRD) for a motorsport race using a communication subsystem;
   ii. selecting, by a targeting module, a target group of spectators based on predetermined criteria;
   iii. transmitting, by a transmitting module, the acquired MRRD to the target group of spectators; and
   iv. allowing the target group of spectators to engage with the motorsport race by using the MRRD to place parimutuel wagers about motorsport race outcomes.
28. The method as claimed in paragraph 27, further comprising amalgamating and reformatting the MRRD into a standardized data feed that is receivable by parimutuel platforms that provide real-time odds for betting based upon the analyzed data.
29. The method as claimed in paragraph 27, wherein acquiring step also acquires transmission signals of live motorsport races, chosen from the group consisting of broadcast and streaming signals.
30. The method as claimed in paragraph 27, wherein the allowing also includes allowing the target group of spectators to use the MRRD to place bets, including over and under ones, about aspects of a motorsport race chosen from the group consisting of the driver who had the lead for the most laps, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.
31. The method as claimed in paragraph 27, wherein the acquiring includes using a communication subsystem with at least one sensor for real-time data acquisition of motorsport races.
32. The method as claimed in paragraph 27, wherein the selecting step is based upon predetermined criteria that include at least one of geographical location, user preferences, and user demographics.
33. The method as claimed in paragraph 27, wherein the allowing step allows the target group of spectators to place parimutuel wagers on the finish order.
34. A computer-readable medium comprising computer-executable instructions for implementing the method of enhancing the spectator experience during a motorsport race, as recited in paragraph 27.
35. A system for enhancing spectator engagement during an auction, the system configured for use in relation to an auction conducted by an auction house, the auction including at least one offer to bidders of an item for sale and at least one unknown outcome for the at least one offer, the auction producing a known outcome, the system configured for identifying the at least one unknown outcome to a target group prior to the bidding and for reporting to the target group of spectators the known outcome at conclusion of the bidding, the system further configured for assessing a level of spectator engagement with the auction prior to the conclusion of the bidding, comprising:
   i. a communication subsystem configured to acquire auction-related data (ARD) associated with the auction, the ARD including the at least one offer of the item for sale and the at least one unknown outcome for the item for sale;
   ii. a targeting module configured to select a target group of spectators based on predetermined criteria;
   iii. a transmission module configured to transmit the acquired ARD to the target group of spectators; and
   iv. an engagement module allowing the target group of spectators to interact with the auction by using the ARD, the engagement module measuring the level of spectator engagement.
36. The system as claimed in paragraph 35, wherein the engagement module measures the level of spectator engagement by offering wagers to the target group of spectators and collecting wagers from the target group of spectators.
37. The system as claimed in paragraph 35, further comprising an allocation module configured to designate and transmit to the auction house a portion of the wagers.
38. The system as claimed in paragraph 35, wherein the engagement module provides to the target group of spectators, prior to the bidding, an estimated successful bid amount.
39. The system as claimed in paragraph 35, wherein the engagement module provides to the target group of spectators, during the bidding, at least one update to the estimated successful bid amount.
40. The system as claimed in paragraph 35, wherein the engagement module offers wagers to the target group of spectators based on the estimated successful bid amount.
41. The system as claimed in paragraph 35, wherein the ARD acquired by the communication subsystem includes information related to the item for sale, such as description, an estimated successful bid amount, and current bid status.
42. The system as claimed in paragraph 35, wherein the targeting module selects the target group of spectators based on predetermined criteria, including user preferences, user demographics, and previous betting behavior.
43. The system as claimed in paragraph 35, further comprising a data processing module configured to analyze the ARD and provide real-time successful-bid odds during the auction based on the analyzed data, including an estimated success bid amount for the at least one item and bid histories.
44. The system as claimed in paragraph 35, wherein the engagement module allows the target group of spectators to place bets on the successful-bid amount in real-time, with the option to alter their bets during the auction.
45. The system as claimed in paragraph 35, wherein the auction is chosen from the group consisting of automobiles, motorcycles, watercraft, aircraft, furniture, real estate, art, antiquities, jewelries, fire arms, animals and collectibles.
46. A method for enhancing spectator experience during an auction, comprising the steps of:
   i. acquiring auction-related data (ARD) associated with the auction and an estimated successful bid amount using a communication subsystem;
   ii. selecting a target group of spectators based on predetermined criteria;
   iii. transmitting the acquired ARD to the target group of spectators; and
   iv. allowing the target group of spectators to interact with the auction by using the ARD to place bets associated with auction-bid outcomes.
47. The method as claimed in paragraph 46, wherein the acquired ARD includes information related to auction items, such as descriptions, values, and current bid status.
48. The method as claimed in paragraph 46, wherein the step of selecting the target group of spectators is based on predetermined criteria, including user preferences, user demographics, and previous betting behavior.
49. The method as claimed in paragraph 46, further comprising the step of analyzing the ARD analyze the ARD and provide real-time successful-bid odds based on the analyzed data, including current auction item values and bid histories.
50. The method as claimed in paragraph 46, wherein the step of allowing the target group of spectators to place bets on the successful-bid amount in real-time, with the option to increase their bets during the auction.
51. The method as claimed in paragraph 46, wherein the auction is chosen from the group consisting of automobiles, motorcycles, watercraft, aircraft, furniture, real estate, art, antiquities, jewelries, firearms, animals (horses, bulls), and collectibles.
52. A computer-readable medium comprising computer-executable instructions for implementing the method of betting on an auction bid for an auction bid, as recited in paragraph 46.
53. A system for use in relation to an animal event produced by an event producer, the animal event occurring between a beginning time and a completion time and producing one or more categories of interim outcomes between the beginning time up to the completion time, wherein the interim outcomes are unknown prior to the beginning time, the system configured for identifying the one or more categories of interim outcomes to a target group of spectators, the system further configured for reporting to the target group of spectators in a period between the beginning time and the completion time the interim outcomes as they become known during the event, and for measuring a level of spectator engagement with the event, the system, the system configured for enhancing spectator experience during the animal event, comprising:
   i. a communication subsystem configured to acquire animal-event-related data (AERD) for the animal event, the AERD including the one or more categories of interim outcomes before the beginning time of the event and the interim outcomes as they become known during the event;
   ii. a targeting module configured to select a target group of spectators based on a predetermined criteria;
   iii. a transmission module configured to transmit the acquired AERD to the target group of spectators before the beginning time of the animal event and during the animal event; and
   iv. an engagement module allowing the target group of spectators to interact with the animal event by using the AERD, the engagement module measuring the level of spectator engagement.
54. The system as claimed in paragraph 53, further comprising a wager offering module configured to offer wagers to the target group of spectators on interim outcomes between the beginning time and the completion time.
55. The system as claimed in paragraph 53, wherein the engagement module allows for the target group of spectators to place wagers between the beginning time and the completion time on one or more of the interim outcomes.
56. The system as claimed in paragraph 53, wherein the engagement module measures the level of spectator engagement.
57. The system as claimed in paragraph 53, further comprising an allocation module configured to designate and transmit to the event producer a portion of the wagers.
58. The system as claimed in paragraph 53 and paragraph 57, wherein the allocation module splits the portion of wagers between an owner of the animal, a jockey of the animal and a trainer.
59. The system as claimed in paragraph 53, further comprising a data-processing module configured to analyze the AERD and provide real-time odds for betting on animal-event outcomes based on the analyzed data.
60. The system as claimed in paragraph 53, wherein the communication subsystem further comprises one or more sensors for real-time data acquisition of the animal event.
61. The system as claimed in paragraph 53, wherein the predetermined criteria for selecting the target group of spectators includes at least one of geographical location, user preferences, and user demographics.
62. The system as claimed in paragraph 53, wherein the engagement module enables the target group of spectators to place bets on interim outcomes for the animal events, the interim outcomes chosen from the group consisting of final times and other data pertinent to animals, animal-trainers, animal-riders, and specific event outcomes other than final times.
63. The system as recited in paragraph 53, wherein a two-way communication is established between the animal event and the spectator, wherein the two-way communication allows the spectator to have an increased level of spectator engagement during the animal event.
64. The system as claimed in paragraph 53, wherein the animal event is chosen from the group consisting of rodeos, stock shows, bullfights, and circuses.
65. A method for enhancing spectator experience during an animal event, comprising the steps of:
   i. acquiring animal-event-related data (AERD) for the animal event using a communication subsystem;
   ii. selecting a target group of spectators based on predetermined criteria;
   iii. transmitting the acquired AERD to the target group of spectators; and
   iv. allowing the target group of spectators to engage with the animal event by using the AERD to place bets about animal-event outcomes.
66. The method as claimed in paragraph 65, further comprising real-time analysis of the AERD which provides updated odds for betting to the target group of spectators.
67. The method as claimed in paragraph 65, wherein the predetermined criteria for selecting the target group of spectators includes at least one of geographical location, user preferences, and user demographics.
68. The method as claimed in paragraph 65, wherein the step of allowing the target group of spectators to engage with the animal event, specific game and domesticated animal events.
69. The method as claimed in paragraph 65, wherein all the AERD is amalgamated into a standardized date format to enable transmission through plural third parties involved in betting.
70. The method as claimed in paragraph 65, wherein the animal event is chosen from the group consisting of rodeos, stock shows, bullfights, and circuses.
71. A computer-readable medium comprising computer-executable instructions for implementing the method of enhancing the spectator experience during an animal event, as recited in paragraph 65.

While there has been shown, and described herein what are presently considered the preferred embodiments of the present disclosure, it will be apparent to those skilled in the art that various changes and modifications can be made therein without departing from the scope of the present disclosure as defined by the appended claims.

While certain embodiments have been described, these embodiments have been presented by way of example only and are not intended to limit the scope of the present disclosure. Indeed, the novel devices, and systems described herein may be embodied in a variety of other forms. Furthermore, various omissions, substitutions, and changes in the form of the devices, and systems described herein may be made without departing from the spirit of the present disclosure. The accompanying claims and their equivalents are intended to cover such forms or modifications as would fall within the scope and spirit of the present disclosure.

Moreover, although the present invention and its advantages have been described in detail, it should be understood that various changes, substitutions and alterations can be made herein without departing from the invention as defined by the appended claims. Moreover, the scope of the present application is not intended to be limited to the particular embodiments of the machine, manufacture, composition of matter, and means, described in the specification. As one will readily appreciate from the disclosure, processes, machines, manufacture, compositions of matter, means, presently existing or later to be developed that perform substantially the same function or achieve substantially the same result as the corresponding embodiments described herein may be utilized. Accordingly, the appended claims are intended to include within their scope such processes, machines, manufacture, compositions of matter, means.

What is claimed:

1. A system for use in relation to a motorsport race produced by an event producer, the system configured for collecting wagers from a betting populace and for allocating a portion of the wagers as revenue to the event producer and for enhancing spectator experience during a motorsport race, comprising:
a communication subsystem configured to acquire motorsport race-related data (MRRD) for the motorsport race;
a targeting module configured to select a target group of spectators based on a predetermined criteria;
a transmission module configured to transmit the acquired MRRD to the target group of spectators;
an engagement module configured to allow the target group of spectators to interact with the motorsport race by using the MRRD to place parimutuel wagers about motorsport race outcomes; and
an allocation module configured to designate and transmit to the event producer a portion of the parimutuel wagers.

2. The system as claimed in claim 1, further comprising a data processing module configured to amalgamate and reformat the MRRD into a standardized data feed that is receivable by parimutuel platforms that provide real-time odds for betting based upon the analyzed data.

3. The system as claimed in claim 1, wherein the communication subsystem is also configured to acquire transmission signals of live motorsport races, chosen from the group consisting of broadcast and streaming signals.

4. The system as claimed in claim 1, wherein the engagement module is also configured to allow the target group of spectators to use the MRRD to place bets, including over and under ones, about aspects of a motorsport race chosen from the group consisting of the driver who had the lead for the most laps, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.

5. The system as claimed in claim 1, wherein the communication subsystem further comprises one or more sensors for real-time data acquisition of the motorsport race.

6. The system as claimed in claim 1, wherein the predetermined criteria for selecting the target group of spectators includes at least one of geographical location, user preferences, and user demographics.

7. The system as claimed in claim 1, wherein the engagement module enables the target group of spectators to place parimutuel wagers on the finish order.

8. The system as claimed in claim 1, wherein a two-way communication is established between the motorsport race and the spectator, wherein the two-way communication allows the spectator to have enhanced engagement with the motorsport race.

9. A method for enhancing the spectator experience during an motorsport race, comprising the steps of:
acquiring motorsport race-related data (MRRD) for a motorsport race using a communication subsystem;
selecting, by a targeting module, a target group of spectators based on predetermined criteria;
transmitting, by a transmitting module, the acquired MRRD to the target group of spectators; and
allowing the target group of spectators to engage with the motorsport race by using the MRRD to place parimutuel wagers about motorsport race outcomes.

10. The method as claimed in claim 9, further comprising amalgamating and reformatting the MRRD into a standardized data feed that is receivable by parimutuel platforms that provide real-time odds for betting based upon the analyzed data.

11. The method as claimed in claim 9, wherein acquiring step also acquires transmission signals of live motorsport races, chosen from the group consisting of broadcast and streaming signals.

12. The method as claimed in claim 9, wherein the allowing also includes allowing the target group of spectators to use the MRRD to place bets, including over and under ones, about aspects of a motorsport race chosen from the group consisting of the driver who had the lead for the most laps, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.

13. The method as claimed in claim 9, wherein the acquiring includes using a communication subsystem with at least one sensor for real-time data acquisition of motorsport races.

14. The method as claimed in claim 9, wherein the selecting step is based upon predetermined criteria that include at least one of geographical location, user preferences, and user demographics.

15. The method as claimed in claim 9, wherein the allowing step allows the target group of spectators to place parimutuel wagers on the finish order.

16. A computer-readable medium comprising computer-executable instructions for implementing the method of enhancing the spectator experience during a motorsport race, as recited in claim 9.
